(19) United States
(12) Patent Application Publication
(10) Pub. No.: US 2026/0014506 A1
(43) Pub. Date: Jan. 15, 2026

(54) FILTER ELEMENT FOR GASEOUS MEDIA, FILTER DEVICE, USE OF A FILTER ELEMENT, AND METHOD FOR ASSEMBLING A FILTER DEVICE

(71) Applicant: MANN+HUMMEL GmbH, Ludwigsburg (DE)

(72) Inventors: Klaus-Dieter RUHLAND, Meckenheim (DE); Michael KAUFMANN, Meckenheim (DE)

(21) Appl. No.: 19/336,629

(22) Filed: Sep. 23, 2025

Related U.S. Application Data
(63) Continuation of application No. PCT/EP2024/057706, filed on Mar. 22, 2024.

(30) Foreign Application Priority Data
Mar. 23, 2023 (DE) 102023107300.1

(51) Int. Cl. B01D 46/00; B01D 45/12; B01D 50/20

(52) U.S. Cl. CPC B01D 46/0005; B01D 45/12; B01D 50/20; B01D 2271/02

(57) ABSTRACT

A filter element for gaseous media for a filter device has a filter medium body with inflow side and outflow side at opposed axial ends. A frame element connected to the filter medium body extends at least partially circumferentially around the filter medium body and radially projects past it. A circumferential seal, provided at a frame side element facing the inflow side, extends circumferentially around a virtual axis. At least one support section, disposed at a frame element side facing the outflow side, supports the filter element at least axially in a filter housing of a filter device. The support section has at least two support surfaces, distributed about a circumferential extension of the frame element and spaced apart axially. The circumferential seal has a circumferential seal stay projecting in axial direction and sealing at least partially radially in relation to a seal surface of the filter housing.

### CROSS-REFERENCE TO RELATED APPLICATIONS

This application is a continuation application of international application No. PCT/EP2024/057706 having an international filing date of Mar. 22, 2024, and designating the United States, the international application claiming a priority date of Mar. 23, 2023, based on prior filed German patent application No. 10 2023 107 300.1, the entire contents of the aforesaid international application and of the aforesaid German patent application being incorporated herein by reference.

### BACKGROUND

The invention concerns a filter element for gaseous media, for example an air filter element, for a filter device, including:
at least one filter medium body, including an inflow side and an outflow side which are present, in relation to a virtual axis, at axial ends of the filter medium body facing away from each other, respectively,
a frame element at least partially extending circumferentially around the at least one filter medium body, which, in relation to the axis, radially projects past the filter medium body and is connected to the at least one filter medium body,
wherein, at a side of the frame element facing the inflow side, a seal is provided which extends circumferentially around the axis,
and wherein, at a side of the frame element facing the outflow side, at least one support section is present by means of which the filter element may be supported at least in axial direction in relation to the axis in a filter housing of the filter device.

Furthermore, the invention concerns a filter device for gaseous media, for example for air, including:
a filter housing with at least one inlet opening for gaseous medium to be purified and at least one outlet opening for the purified gaseous medium,
wherein at least one filter element, which includes at least one filter medium body, is arranged in the filter housing between the at least one inlet opening and the at least one outlet opening in relation to the gas flow in such a way that it separates a raw side correlated with the inlet opening from a clean side correlated with the outlet opening,
wherein the filter housing includes a first housing part at which the at least one outlet opening is arranged and which includes at least one filter element receiving space in which the at least one filter element is arranged,
and wherein the filter housing includes a second housing part at which the at least one inlet opening is arranged and which includes one or more parts of at least one cyclone separator,
wherein the second housing part closes off a service opening of the first housing part and the first and the second housing parts are releasably connected to each other and separable from each other in order to be able to remove the at least one filter element through the service opening of the first housing part.

Moreover, the invention concerns the use of a filter element including at least one filter medium body in a filter device for gaseous media.

In addition, the invention concerns a method for assembly of a filter device for gaseous media, in which at least one filter element is inserted through a service opening into a filter element receiving space of a first housing part, which includes at least one outlet opening for purified gaseous medium, of a filter housing of the filter device and, subsequently, the service opening is closed off by a second housing part of the filter housing, which includes at least one inlet opening for gaseous medium to be purified and one or more parts of at least one cyclone separator.

US 2021/0077932 A1 discloses an air filter assembly which includes a housing with a body, an access cover, an air flow inlet, and an air flow outlet. Furthermore, it includes an air filter cartridge which is operatively arranged in the housing, wherein the axial pinch seal is pretensioned by the access cover against the body.

The invention has the object to design a filter element, a filter device, the use of a filter element, and a method for assembly of a filter device of the aforementioned kind in which the filter device is improved, for example the filter device is improved in relation to function, mounting and/or assembly.

### SUMMARY

This object is solved by the filter element according to the invention in that the at least one support section includes at least two support surfaces, distributed about the circumferential extension in relation to the axis and are spaced apart from each other in axial direction in relation to the axis, and the circumferential seal includes a circumferential seal stay which projects in relation to the axis in axial direction and is configured to seal at least partially radially in relation to the axis in relation to a corresponding seal surface of the filter housing.

In an embodiment, the support section may include at least two, for example four, support surfaces, distributed about the circumference, which are spaced apart from each other in the axial direction, respectively. In this way, a protection against wrong mounting of the filter element in the filter housing may be realized by means of the support surfaces at different heights.

In a further embodiment, the seal stay, in the axial direction in relation to the axis, may project past the inflow side of the at least one filter medium body. In this manner, the inflow side of the filter medium body may be arranged radially inside of the circumferential seal stay in relation to the axis.

In a further embodiment, the seal stay may be arranged immediately adjacent to, in relation to the axis, a radially outer wall surface of the frame element, and/or the seal stay may be arranged completely radially outside of, in relation to the axis, a radially outer wall surface of the at least one filter medium body.

The seal stay may be arranged immediately adjacent to the radially outer wall surface of the frame element. In this manner, the seal stay may be supported by the frame element for example in axial direction in relation to the axis.

As an alternative or in addition, the seal stay may be arranged completely radially outside of the radially outer wall surface of the at least one filter medium body. In this manner, the seal stay and the at least one filter medium body may be better separated in relation to a contact pressure for realizing the sealing action.

In a further embodiment, the frame element may be realized to be less flexible than the circumferential seal, for example the frame element may be formed of a harder material than the circumferential seal, and/or the seal may include or be included of elastic material, for example an elastomer, for example a foamed elastomer, and/or the frame element may include or be included of plastic material, for example injection-moldable hard plastic material.

The frame element may be realized to be less flexible than the circumferential seal. In this manner, by means of the frame element a support function and by means of the seal a better deformability may be realized. In this context, the different flexibility may be realized by means of different materials and/or by means of different shaping.

The frame element may be formed of a harder material than the circumferential seal. In this manner, the frame element may be formed to be less flexible than the seal. The material may be a single material or a material mixture, for example a composite material.

As an alternative or in addition, the frame element may be realized at least in sections from the same material as the seal, for example from a seal material. In this manner, a connection of the frame element and of the seal may be improved.

As an alternative or in addition, the frame element and the seal may be realized as a multi-component part, for example two-component part. In this manner, the manufacture may be simplified.

The seal and the frame element may be produced by a multi-component injection molding method, for example a two-component injection molding method.

As an alternative or in addition, the seal may include or be included of elastic material. In this manner, the seal may be deformed. An elastic seal may be produced simply from an elastomer, for example foamed elastomer.

As an alternative or in addition, the frame element may include or be included of plastic material. In this manner, a stable and lightweight frame element may be realized. A hard and robust frame element may be realized simply by means of injection molding from injection-moldable hard plastic material. Complex shapes for the frame element may be realized also by means of injection molding.

In a further embodiment, the circumferential seal may be delimited by the frame element at a side which is facing the outflow side, and/or a surface of the frame element which is facing the outflow side may be exposed at least in sections and provide the at least one support section. Due to the delimitation by the frame element, the circumferential seal may be supported at the frame element at the side which is facing the outflow side. In the exposed sections, the surface of the frame element may contact a corresponding section of the filter housing without interposition of seal material.

In a further embodiment, the frame element, beginning at the support section, may extend radially inwardly and/or in the direction toward the inflow side, and/or the frame element may be embedded, at least in sections, by material of the circumferential seal.

The frame element may extend, beginning at the support section, radially inwardly and/or in the direction toward the inflow side. In this manner, a stabilization for at least one filter medium body may be realized. Furthermore, a part of the frame element may serve in this manner as a casting mold for material of the seal.

As an alternative or in addition, the frame element may be embedded, at least in sections, in material of the circumferential seal. In this manner, a support action for the seal may be improved.

In a further embodiment, the frame element, in relation to its course at least at its radially outer wall surface and/or at its radially inner wall surface, may exhibit no rotational symmetry in relation to the axis. In this manner, wrong mounting of the filter element, for example wrong alignment, upon installation into the filter housing may be prevented.

In a further embodiment, the frame element, along its course extending around the axis, may include at least four sections of which the respective neighboring sections include differently curved, even straight courses, and, in case of at least one pair of respectively two of the sections on opposite sides of the axis, the corresponding sections have differently curved courses, and/or the circumferential seal stay projecting in axial direction may include at least four sections along its course extending around the axis, of which the respective neighboring sections include differently curved, even straight courses, and, in case of at least one pair of respectively two of the sections on opposite sides of the axis, the corresponding sections include differently curved courses. In this manner, a rotational symmetry of the frame element and/or of the seal stay in relation to the axis may be avoided. In this way, a wrong mounting of the filter element in the filter housing may be prevented.

In a further embodiment, the frame element may include at least two curved sections curved in relation to their circumferential course around the axis, which are connected by two connection sections, for example two straight connection sections straight in relation to their circumferential course around the axis, wherein the connection sections, for example the straight connection sections, are present at long sides of the frame element, which are opposite each other in relation to the axis, and the two curved sections are present at short sides of the frame element, which are opposite each other in relation to the axis, and/or the circumferential seal stay projecting in axial direction includes at least two curved sections curved in relation to their circumferential course around the axis, which are connected by two connection sections, for example two straight connection sections straight in relation to their circumferential course around the axis, wherein the connection sections, for example the straight connection sections, are present at long sides of the seal stay, which are opposite each other in relation to the axis, and the two curved sections are present at short sides of the seal stay, which are opposite each other in relation to the axis. In this manner, a rotational symmetry of the frame element and/or of the seal stay in relation to the axis may be avoided. In this way, wrong mounting of the filter element in the filter housing may be prevented.

In a further embodiment, the frame element may include a first curved section and a second curved section, wherein the first curved section at least in sections includes a larger radius of curvature than the second curved section, and/or the circumferential seal stay projecting in axial direction may include a first curved section and a second curved section, wherein the first curved section at least in sections includes a larger radius of curvature than the second curved section. Due to the different curvatures of the curved sections in combination with different lengths of the connection sections and of the curved sections, a rotational symmetry in relation to the axis may be avoided.

In a further embodiment, the first curved section of the frame element may include a flattened region in which the radius of curvature in relation to the radius of curvature of the second curved section is reduced, and/or the first curved section of the seal stay may include a flattened region in which the radius of curvature in relation to the radius of curvature of the second curved section is reduced. In this way, different radii of curvature may be realized simply.

In a further embodiment, at least one of the support surfaces of the frame element may be present at least partially in the region of a long side of the frame element. In this manner, a large surface area support action may be realized.

In a further embodiment, the, in relation to the axis, radially outer wall surface of the filter medium body may include at least two curved sections curved in relation to their circumferential course around the axis which are connected by two connection sections, for example two straight connection sections, and/or an outer circumference of the filter medium body decreases, viewed in axial direction, from the inflow side to the outflow side, for example the filter medium body may taper, for example taper conically, in relation to its radially outer side, when viewed in axial direction from the inflow side toward the outflow side.

Due to the combination of the at least two curved sections and the connection sections, an oval outer shape of the filter medium body, viewed in the direction of the axis, may be realized. The two connection sections may be straight. In this manner, an elongate oval outer shape of the filter medium body may be realized.

Due to the reduction of the outer circumference, viewed from the inflow side to the outflow side, a space surrounding the filter medium body may be enlarged within the filter housing.

In a further embodiment, the filter medium body may be flowed through in the radial direction in relation to the axis from the interior to the exterior or in reverse. In this manner, a ratio between required installation space and available active filter surface area of the filter medium body may be improved for the benefit of the active filter surface.

In a further embodiment, the at least one filter medium body may include at least two filter bellows, for example an inner filter bellows and an outer filter bellows, for example at least two folded filter bellows which at least partially extend around the axis and may be flowed through in parallel by the gaseous medium to be purified, and/or an inner filter bellows of the at least one filter medium body may be arranged in an interior which is enclosed by an outer filter bellows of the at least one filter medium body, and/or the at least one filter medium body may include at least one filter bellows, for example an inner filter bellows and/or an outer filter bellows which includes a slant in relation to the axis. By use of a plurality of filter bellows and their particular arrangement relative to each other, a ratio of required space to active filter surface area to be flowed through may be improved as a whole.

In this context, “to be flowed through in parallel” means that the filter bellows are arranged operationally, for example in relation to the flow of the gaseous medium, in a parallel acting manner. This does not mean that the filter bellows are arranged parallel in the geometric sense. The filter bellows are flowed through in parallel by the gaseous medium to be purified. In contrast thereto, in a serial arrangement of the filter bellows, they are flowed through one after another, i.e., serially.

In a further embodiment, at least one fluid-permeable support element may be present, in relation to the axis, radially between the at least two filter bellows, for example radially between the inner filter bellows and the outer filter bellows, at which at least one of the at least two filter bellows, for example an inner filter bellows and/or an outer filter bellows, is supported at least in sections, and/or the filter element includes at least one support element at which at least one of the filter bellows is supported, wherein the at least one support element may be formed as one piece together with the frame element. By means of the support element, the shape stability of the filter medium body may be improved. In this context, the fluid permeability makes it possible that the flow of gaseous medium is not impaired.

The filter element may include at least one support element at which at least one of the filter bellows is supported, wherein the at least one support element may be formed as one piece together with the frame element. In this manner, the mechanical stability may be further improved.

The support element and/or the frame element may be part of a skeleton. By means of the skeleton, the entire shape of the filter element may be stabilized.

Furthermore, the object is solved according to the invention for the filter device in that at least one of the filter elements is a filter element according to the invention.

Still further, the object is solved according to the invention for the use in that the filter element is a filter element according to the invention.

In addition, the object is solved according to the invention for the method in that at least one filter element according to the invention is introduced into the filter element receiving space.

A filter device for gaseous media, for example for air, may include:
a filter housing with at least one inlet opening for gaseous medium to be purified and at least one outlet opening for the purified gaseous medium,
wherein at least one filter element, which includes at least one filter medium body, is arranged in the filter housing between the at least one inlet opening and the at least one outlet opening in relation to the gas flow in such a way that it separates a raw side correlated with the inlet opening from a clean side correlated with the outlet opening,
wherein the filter housing includes a first housing part at which the at least one outlet opening is arranged and which includes at least one filter element receiving space in which the at least one filter element is arranged,
and wherein the filter housing includes a second housing part at which the at least one inlet opening is arranged and which includes one or more parts of at least one cyclone separator,
wherein the second housing part closes off a service opening of the first housing part and the first and the second housing parts are releasably connected to each other and separable from each other in order to be able to remove the at least one filter element through the service opening of the first housing part.

The at least one filter element may include a seal, circumferentially extending around a virtual axis, at an inflow side facing the second housing part, the seal including a seal section, acting sealingly at least partially radially relative to the axis and circumferentially extending around the axis, wherein, in relation to the axis, a radially outer circumferential side of the seal section rests seal-tightly, in relation to the axis, at a radially inner interior wall surface of the first housing part, wherein for example a rib, circumferentially extending at least partially around the axis and projecting away from the second housing part with at least one directional component in axial direction in relation to the axis, exerts a contact pressure on the circumferential seal in order to press the at least partially radially sealingly acting circumferential seal section against the interior wall surface of the first housing part.

The second housing part may include a circumferential rib by means of which, when the filter device is assembled, a contact pressure is exerted on the circumferential seal. As a result of the contact pressure, an at least partially radially sealingly acting circumferential seal section is pressed against an interior wall surface of the first housing part. In this manner, the filter element receiving space is sealed by means of the seal in relation to the environment. Furthermore, the raw side of the filter element is separated from the clean side in this way.

By means of the at least partially in radial direction acting seal section, it is achieved that a seal surface of the seal on the part of the at least one filter element, in a non-clamped state of the first housing part in relation to the second housing part, includes a clearance, for example a radial gap, in relation to a counterpart surface of the filter housing, namely the interior wall surface of the first housing part. Only by clamping the second housing part to the first housing part, the circumferential seal section is pressed against the interior wall surface of the first housing part. In this way, the sealing action between the first housing part, the second housing part, and the filter element is generated. In addition, a cyclone block which includes the at least one cyclone separator is sealed axially in relation to the axis by the seal.

As a whole, the construction of the filter device according to the invention enables a simple mounting of the filter element in the filter housing without a force effect. The clamping of the seal may be realized by an axial clamping action of the first housing part at the second housing part. A lever action of suitable closure elements may be utilized for this purpose.

By means of the seal, an ingress of particles and/or water to the clean side between the at least one filter element and the filter housing may be prevented. In addition, also an ingress of particles and/or water into a region between the at least one filter element and the second housing part, for example an immersion tube plate and/or a cyclone block, may be prevented.

The filter device and the filter element may be used in vehicles, for example motor vehicles, in construction and/or agricultural machines, compressors, in connection with internal combustion engines, in cathode filters, for example in connection with fuel cells.

The gaseous medium to be purified may be air. In this case, the filter device may also be referred to as air filter device. By means of the filter device, solid or liquid particles may be removed from the gaseous medium.

The axis may coincide with a housing axis of the filter housing, an installation/removal axis of the filter element into the first housing part, a connection axis of the first housing part and the second housing part and/or an element axis of the filter element. When in the specification “radial”, “coaxial”, “axial”, “tangential”, “circumferential”, “concentric”, “eccentric” or the like is mentioned, this relates to the virtual axis, if nothing else is mentioned. In this context, “circumferential” relates to a virtual wall surface which surrounds the virtual axis. The virtual axis may be for example a longitudinal axis.

The second housing part may be clamped by means of a clamping device to the first housing part. By means of the clamping device, a driving force acting at least in axial direction between the first housing part and the second housing part may be realized. The clamping device may be releasable. The clamping device may include at least one clamping element, for example at least one screw, at least one clamping hook and/or at least one snap hook or the like. The clamping device may engage directly at the second housing part. As an alternative or in addition, the clamping device may engage at a cyclone housing, wherein, between the latter and the first housing part, the second housing part is arranged.

The at least one cyclone separator, for example a cyclone block with a plurality of cyclone separators, may include at least one dust discharge device.

The at least one cyclone separator may be an axial cyclone.

The filter device may include at least one cyclone block which includes a plurality of cyclone separators. In this manner, a larger gas flow may be purified and the available construction space may be optimally utilized.

The at least one inlet opening and the at least one outlet opening may be located, in relation to the axis, at axially opposed sides of the filter housing.

The at least one filter medium body may include at least one filter bellows, for example at least one single bellows and/or at least one double bellows.

The filter medium body may include a filter medium, for example filter paper, filter nonwoven, filter foam or the like, which is suitable for filtering gaseous medium, for example air.

The filter medium of the at least one filter medium body may be folded or wound. In this manner, the active filter surface area may be enlarged. The filter element may be designed correspondingly as a folded filter element or as a wound filter element.

The at least one filter element may be a compact filter element, a hollow filter element, a flat filter element or the like.

The filter medium body may include for example a zigzag-shaped folded filter medium with deep folds. In case of an approximately cuboid or prism-shaped filter medium body, one speaks of deep folds for example when a fold height is at least as large as the expansion in the direction of the fold edges and/or in the direction transverse to the fold edges.

A hollow filter element is characterized in that it includes at least one element interior which is surrounded by filter medium.

The hollow filter element may be a so-called round filter element with a round cross section, an oval round filter element with an oval cross section, a flat oval round filter element with a flattened oval cross section, a conical round filter element in which the round cross section in axial direction tapers in relation to a main axis, a conical oval round filter element in which the oval cross section tapers in axial direction at least in direction of one transverse axis, a conical flat oval round filter element in which the flat oval cross section in axial direction tapers at least in direction of one transverse axis, or a hollow filter element with a different type of cross section, for example an angular cross section and/or a different type of axial cross sectional course in direction of an element axis.

The rib may be fixedly arranged, for example in relation to the pressure load, for example stationarily, at the second housing part. In this manner, the rib is displaced together with the second housing part upon axial assembly of the first housing part and the second housing part with interposition of the at least one filter element. This would not be possible if the second housing part were a component of the at least one filter element. For example, the rib is displaced together with the second housing part by the clamping action of a clamping device upon assembly.

The raw side is the side where the gaseous medium still to be purified is located during operation of the filter device. The clean side is the side where purified gaseous medium is located.

The rib may support the at least partially radially sealingly acting circumferential seal section at a radially inner circumferential side of the seal section, for example at a radially inner circumferential side of the seal section which is radially opposite the interior wall surface of the first housing part. In this manner, the seal section may be pressed against the interior wall surface of the first housing part by means of the rib, for example directly.

The contact pressure exerted by the rib may include at least one directional component which, in relation to the axis, is oriented radially from the interior to the exterior. In this manner, the corresponding seal section may be pressed directly with the radial sealing force outwardly against the interior wall surface of the first housing part. The contact pressure exerted by the rib may thus directly produce the radial sealing force.

As an alternative or in addition, the contact pressure exerted by the rib may include a directional component which is oriented at least parallel to the axis. In this manner, the at least one seal may be compressed in axial direction. The seal material may yield to the compression radially outwardly and thus press, radially acting, on the interior wall surface of the first housing part. The contact pressure exerted by the rib may thus produce the radial sealing force indirectly, for example by deformation of the seal in transverse direction.

The at least one seal section of the circumferential seal may be deformed in the filter housing with the at least one filter element mounted in comparison to the not yet mounted at least one filter element. The corresponding seal section may thus be pressed flexibly against the interior wall surface of the first housing part.

The rib may contact the circumferential seal at an axial end face, axial in relation to the axis and facing the second housing part, with a directional component of the contact pressure acting in axial direction in relation to the axis. In this manner, the circumferential seal may be deformed by compression. The deformed seal may thus be pressed, acting partially radially sealingly, against the interior wall surface of the housing.

The rib may contact, for example directly, the circumferential seal at an inflow-side end face in axial direction in order to effect a deformation of the circumferential seal and press the partially radially acting circumferential seal section against the interior wall surface of the housing in this way.

The rib may be embodied ramp-shaped at least in sections, and/or a contact surface of the rib facing the radially inner circumferential side of the at least partially radially sealingly acting circumferential seal section may be positioned at an acute angle to the axis. In this manner, the rib, upon axial assembly of the first housing part and of the second housing part, may glide along the radially inner circumferential side of the seal section and press it successively against the interior wall surface of the first housing part. Due to the wedge action between “angled” rib and seal section, high radially acting seal pretension forces may be achieved by means of manageable axial mounting forces.

The at least partially radially sealingly acting circumferential seal section may be radially outwardly offset at least in sections in relation to, in relation to the axis, a radially outer exterior wall surface of the filter medium body, and/or the at least partially radially sealingly acting circumferential seal section may project at least in sections axially past the inflow side of the filter medium body.

The filter device include a cyclone block with a plurality of cyclone separators, wherein the cyclone block includes an immersion tube plate as a second housing part of the filter housing, which includes a plurality of immersion tubes, and the circumferential rib is formed at the immersion tube plate, and/or the at least one inlet opening may be arranged at the at least one part of the at least one cyclone separator, for example in an immersion tube of the at least one cyclone separator, and/or the second housing part may include parts of a cyclone block which includes a plurality of cyclone separators, and/or the second housing part may include or be an immersion tube plate with at least one immersion tube of a cyclone separator, and/or the second housing part may include a plurality of immersion tubes of corresponding cyclone separators, and/or the second housing part may be arranged between the first housing part and a cyclone housing of a cyclone block to which the at least one cyclone separator belongs. In this manner, the filter device may be designed in a compact configuration with at least one filter element and at least one cyclone block. By means of the cyclone block with a plurality of cyclone separators, an efficient pre-separation of particles from the gaseous medium to be purified may be realized and the construction size requirement for the pre-separation may be minimized.

An inflow-side axial end of the circumferential seal, viewed in a direction axially to the axis, may project past a free end of the rib of the second housing part, and/or the rib, viewed in a direction axially to the axis, may project past a free end of the circumferential seal, for example of the at least one seal section, and/or the rib may dip into a recess of the circumferential seal which is open at its side axially facing the inflow side in relation to the axis, and/or the second housing part may include at least one immersion tube of at least one cyclone separator, which includes an outflow end at its side facing the inflow side of the at least one filter element, which is surrounded by an immersion tube rim section at least in sections, wherein the immersion tube rim section, when the filter device is mounted, may be located at an axial distance to the free end of the circumferential seal radially within the seal section. In this manner, an axial overlap between the seal and the second housing part, for example the rib and/or the immersion tubes, may be realized.

The immersion tube rim section, when the filter device is mounted, may be located at an axial distance to the free end of the seal radially inside of the seal section. The outflow end, viewed axially, may be located beyond the inflow-side axial free end of the circumferential seal. The immersion tube rim section which surrounds the outflow end at least in sections, and thus also the outflow end of the at least one immersion tube, may dip, viewed axially, behind the free end of the circumferential seal and thus behind the inflow-side end of the at least one filter element.

The first housing part may include an at least partially circumferentially extending radially projecting collar which provides at least one axial contact surface at which the at least one radially projecting support section of the filter element is supported. In this manner, the circumferential seal may be supported additionally in relation to the axis in axial direction at the first housing part. Here, a further seal region may be realized. In the further seal region, the at least one circumferential seal may act sealingly in axial direction.

The projecting collar of the first housing part may extend continuously contiguously, for example circumferentially, or be interrupted.

The collar may include at least two axial contact surfaces, for example four axial contact surfaces, which are located at different axial heights, and/or the collar may include at least two collar sections, for example four collar sections, with respective contact surfaces which extend each partially circumferentially around the axis. In this manner, a protection against wrong assembly of the filter device may be realized. For example, a wrong orientation of the at least one filter element, of the first housing part, and of the second housing part upon assembly may be prevented in this way.

A contact region of the seal section, in which the seal section rests radially sealingly acting at the interior wall surface of the first housing part, may be arranged at an axial distance to the at least one axial contact surface of the collar. In this manner, between the seal section and the interior wall surface of the first housing part, a region may be realized in which the at least one seal section does not contact the interior wall surface.

The first housing part and the second housing part may form a seal chamber in which the at least partially radially acting circumferential seal section is received, wherein the seal chamber is delimited radially inwardly by the rib of the second housing part, radially outwardly by the interior wall surface of the first housing part, and axially by a collar which is connected to the second housing part, for example by a collar of a further part which is connected to the second housing part. In this manner, a space is made available within which the seal section may be accommodated even after a deformation.

The collar may provide an axial seal surface at which the circumferential seal rests acting sealingly in axial direction. In this manner, a sealing action in outward direction, for example to the environment, is made possible.

The seal chamber may be delimited at the inflow side axially by a collar which is connected to the second housing part, for example by a collar of a further part which is connected to the second housing part.

The circumferential seal may be delimited at an axial end which is facing away from the second housing part by a frame element extending at least partially circumferentially around the axis and connected to the filter medium body, wherein the frame element, for example a surface of the frame element, is at least partially exposed, and wherein the frame element, for example at least an exposed section of the frame element, may form at least partially a radially projecting support section of the filter element which is supported at an axial support surface of a radially projecting collar of the first housing part. In this manner, the circumferential seal may be supported at its side which is axially facing away from the second housing part. Furthermore, in this way, the at least one support section may be connected in a stable manner to the filter medium body and a stiff form-fit contact of the filter element at the housing may be realized.

The frame element may include or be included of plastic material. In this manner, the frame element may be realized robust, flexibly and with minimal weight. In this case, also the term “plastic frame” may be used for the frame element. As an alternative or in addition, the frame element may also include or be included of at least one other material, for example metal, carbon fibers or a composite material.

The frame element may be part of a skeleton of the filter element and/or may be connected to a skeleton of the filter element. The at least one filter medium body may be held at the skeleton. By means of the skeleton, the at least one filter element may be stabilized and its shape maintained. At least one part of the skeleton may include or be included of plastic material, metal, carbon fibers or a composite material.

The skeleton, for example the skeleton with the frame element, may be realized as one piece. In this manner, the skeleton may be realized to be particularly stable.

The frame element may also be configured as a component separate from the skeleton in embodiments.

The frame element, beginning at the at least one exposed section, may extend at least in sections in axial direction in the direction of the inflow side and/or radially inwardly, and/or the frame element may be embedded, at least in sections, by material of the circumferential seal.

The frame element may extend at least in sections in axial direction in direction of the inflow side and/or radially inwardly. In this manner, a stabilization for at least one filter medium body may be realized. Furthermore, a part of the frame element may serve in this manner as a casting mold for material of the seal.

As an alternative or in addition, the frame element may be embedded, at least in sections, in material of the circumferential seal. In this manner, a support action for the seal may be improved.

In a state of the filter device in which the at least one filter element is arranged in the at least one filter element receiving space and the second housing part is released from the first housing part, a radial gap may be present between the interior wall surface of the second housing part and the radially outer circumferential side of the at least partially radially sealingly acting circumferential seal section. In this manner, the at least one filter element may be moved in axial direction into the filter element receiving space or out of it without the radially sealingly acting circumferential seal section rubbing against the interior wall surface of the second housing part, whereby the mounting forces may be minimized.

The filter medium body may have a cross-sectional shape including at least two curved sides connected by two for example straight sides, and/or the filter medium body may include a radially outer filter medium section and a radially inner filter medium section which, in relation to the axis, are each circumferentially contiguous, wherein the radially inner filter medium section is arranged within the radially outer filter medium section, and/or an outer wall of the filter medium body, for example of a radially outer filter medium section of the filter medium body, includes an elongate oval cross section, and/or an inner wall of the filter medium body, for example of a radially inner filter medium section of the filter medium body, includes an elongate oval cross section, and/or an outer wall of the filter medium body, for example of a radially outer filter medium section of the filter medium body, tapers, for example tapers conically, viewed from the inflow side in direction of the axis, and/or an inner wall of the filter medium body, for example of a radially inner filter medium body section of the filter medium body, tapers, for example tapers conically, viewed from the outflow side in the direction of the axis. In this manner, a filter medium may be realized which includes an improved ratio between space requirement and filter surface area.

A filter medium section may be realized as a filter bellows. In case of a filter bellows, the filter medium may be folded. In this manner, an enlargement of the active filter surface area may be achieved.

At least one filter medium section of the filter medium body, for example a radially outer filter medium section of the filter medium body, may be flowed through radially from the interior to the exterior, and/or at least one filter medium section of the filter medium body, for example a radially inner filter medium section of the filter medium body, may be flowed through radially from the exterior to the interior. In this manner, a ratio between axial expansion and radial expansion of the filter element may be improved. In this way, a filter element may be realized which is of an elongate configuration in axial direction in comparison to the radial expansion.

The at least one filter medium body may include at least two filter bellows, for example an inner filter bellows and an outer filter bellows, for example at least two folded filter bellows, which at least partially extend around the axis and may be flowed through in parallel by the gaseous medium to be purified, and/or an inner filter bellows of the at least one filter medium body may be arranged in an interior which is surrounded by an outer filter bellows of the at least one filter medium body, and/or the at least one filter medium body may include at least one filter bellows, for example an inner filter bellows and/or an outer filter bellows which includes a slant in relation to the axis. By using a plurality of filter bellows and their special arrangement relative to each other, a ratio of the space requirement to the active filter surface area to be flowed through may be improved as a whole.

In this context, “to be flowed through in parallel” means that the filter bellows are arranged operationally, for example in relation to the flow of the gaseous medium, in a parallel acting manner. This does not mean that the filter bellows are arranged parallel in the geometric sense. The filter bellows are flowed through in parallel by the gaseous medium to be purified. In contrast thereto, in a serial arrangement of the filter bellows, they are flowed through one after another, i.e., serially.

The filter device may include at least one further filter element, for example a secondary filter element, which fluidally is arranged downstream of the at least one filter element, for example a main filter element, including the circumferential seal. In this manner, the separation of particles from the gaseous medium to be purified may be further improved and, as an alternative or in addition, an ingress of contaminations to a clean side during servicing of the main filter element may be prevented.

The at least one further filter element, for example the secondary filter element, may be arranged in the filter element receiving space spatially between the filter element with the at least one circumferential seal and the at least one outlet opening of the filter housing. In this manner, the filter device may be constructed in a more compact configuration.

A filter element for a filter device for gaseous media, for example for air, for example for a filter device according to the invention, may include a filter medium body,
wherein the filter device includes a filter housing with at least one inlet opening and at least one outlet opening,
wherein the filter element may be received in the filter housing between the inlet opening and the outlet opening in order to separate a raw side correlated with the at least one inlet opening from a clean side correlated with the at least one outlet opening,
and wherein the filter housing includes a first housing part at which the outlet opening is arranged and which includes at least one filter element receiving space in which the at least one filter element is arranged,
and wherein the filter housing includes a second housing part at which the inlet opening is arranged and which includes one or more parts of at least one cyclone separator,
wherein the second housing part closes off a service opening of the first housing part and the first and the second housing parts are releasably connected to each other and separable from each other in order to be able to remove the at least one filter element through the service opening of the first housing part.

The at least one filter element at an inflow side, which may be arranged to face the second housing part, includes a seal circumferentially extending around a virtual axis, which includes a seal section, acting at least partially sealingly radially in relation to the axis and extending circumferentially around the axis, wherein, in relation to the axis, a radially outer circumferential side of the seal section may be contacted seal-tightly at, in relation to the axis, a radially inner interior wall surface of the first housing part, wherein by a rib, circumferentially extending at least partially around the axis and projecting away from the second housing part with at least one directional component in axial direction, a contact pressure may be exerted on the circumferential seal in order to press the circumferential seal section, capable of acting at least partially radially sealingly, against the interior wall surface of the first housing part.

The filter element including at least one filter medium body may be used in a filter device for gaseous media according to the invention.

The filter element may include a circumferential seal at an inflow side which is facing a second housing part of the filter device, which includes a circumferential seal section, acting at least partially sealingly radially in relation to a virtual axis, which, in relation to the axis, with a radially outer circumferential side rests seal-tightly at, in relation to the axis, a radially inner interior wall surface of the first housing part, wherein an at least partially circumferential rib, which projects with at least one directional component in an axial direction away from the second housing part, exerts a contact pressure on the circumferential seal in order to press the at least partially radially sealingly acting circumferential seal section against the interior wall surface of the first housing part.

In a method for assembly of a filter device for gaseous media, for example of a filter device according to the invention, at least one filter element may be introduced through a service opening into a filter element receiving space of a first housing part, which includes at least one outlet opening for purified gaseous medium, of a filter housing of the filter device and, subsequently, the service opening may be closed by a second housing part of the filter housing, which includes at least one inlet opening for gaseous medium to be purified and one or more parts of at least one cyclone separator.

A seal, circumferentially extending around a virtual axis at an inflow side of the at least one filter element facing the second housing part, is pressed by a rib, circumferentially at least partially extending around the axis and projecting away from the second housing part with at least one directional component in axial direction in relation to the axis, in an at least partially radially sealingly acting manner against, in relation to the axis, a radially inner interior wall surface of the first housing part.

The at least one filter element may be inserted simply in the filter housing without a force effect.

The installation of the filter element in the filter element receiving space of the first housing part and the attachment of the second housing part to the first housing part may be performed in axial direction in relation to the axis.

A clamping action of the circumferential seal may be realized by means of clamping means which engage between the first housing part and the second housing part.

In other respects, the features and advantages which have been disclosed in connection with the filter element according to the invention, the filter device according to the invention, the use according to the invention, and the method according to the invention and their respective embodiments apply among each other and vice versa. The individual features and advantages can, of course, be combined among each other, wherein further embodiments and advantageous effects may result which go beyond the sum of the individual effects.

### BRIEF DESCRIPTION OF THE DRAWINGS

Further advantages, features and details of the invention result from the following description in which embodiments of the invention will be explained in more detail with the aid of the drawings. A person of skill in the art will consider the features disclosed in combination in the drawings and the description expediently also individually and combine them to expedient further combinations.

FIG. 1 shows an isometric illustration of a filter device for gaseous media with a cyclone block, viewing the side of an outlet socket.

FIG. 2 shows an isometric illustration of the filter device of FIG. 1 without the cyclone block, viewing an inflow side of a main filter element of the filter device.

FIG. 3 shows an exploded illustration of the filter device of FIGS. 1 and 2.

FIG. 4 shows a detail view of an immersion tube plate of the cyclone block of the filter device of FIGS. 1 to 3 in the region of a circumferential rib.

FIG. 5 shows a detail view of the main filter element of the filter device of FIGS. 1 to 3 in the region of a circumferential seal.

FIG. 6 shows a longitudinal section through the filter device of FIGS. 1 to 3.

FIG. 7 shows a detail view of the longitudinal section of the filter device of FIG. 6 in the region of the circumferential seal of the main filter element.

FIG. 8 shows a longitudinal section through the filter device of FIGS. 1 to 3 without a cyclone housing of the cyclone block.

FIG. 9 shows a detail view of the longitudinal section of the filter device of FIG. 8 in the region of the circumferential seal of the main filter element.

FIG. 10 shows a longitudinal section through the filter device of FIGS. 1 to 3 without the cyclone block.

FIG. 11 shows a detail view of the longitudinal section of the filter device of FIG. 10 in the region of the circumferential seal of the main filter element.

FIG. 12 shows an isometric illustration of a housing pot of the filter device of FIGS. 1 and 3, viewing a service opening, wherein an after filter element is arranged in the housing pot.

FIG. 13 shows an illustration of the housing pot of FIG. 12 with an axial viewing direction of the service opening.

FIG. 14 shows a longitudinal section through the housing pot of FIGS. 12 and 13 with the after filter element along a section line XIV-XIV of FIG. 13.

FIG. 15 shows a detail view of the longitudinal section of FIG. 14 in the region of a collar of the housing pot surrounding the service opening.

FIG. 16 shows an isometric illustration of a skeleton of the main filter element of the filter device of FIGS. 1 to 3 with viewing direction of the inflow side of the main filter element.

FIG. 17 shows an isometric illustration of the skeleton of FIG. 16 with viewing direction of the outflow side of the main filter element.

FIG. 18 is a side view of a short side of the skeleton of FIGS. 16 and 17.

FIG. 19 is a side view of a long side of the skeleton of FIGS. 16 to 18.

FIG. 20 shows an isometric illustration of the main filter element of the filter device of FIGS. 1 to 3 with viewing direction of an outflow side.

FIG. 21 shows an isometric illustration of the main filter element of the filter device of FIGS. 1 to 3 with viewing direction of an inflow side.

FIG. 22 shows a side view of a long side of the main filter element of the filter device of FIGS. 1 to 3.

FIG. 23 shows a side view of a short side of the main filter element of the filter device of FIGS. 1 to 3.

In the drawing figures, the same or similar components are provided with the same reference characters.

### DETAILED DESCRIPTION

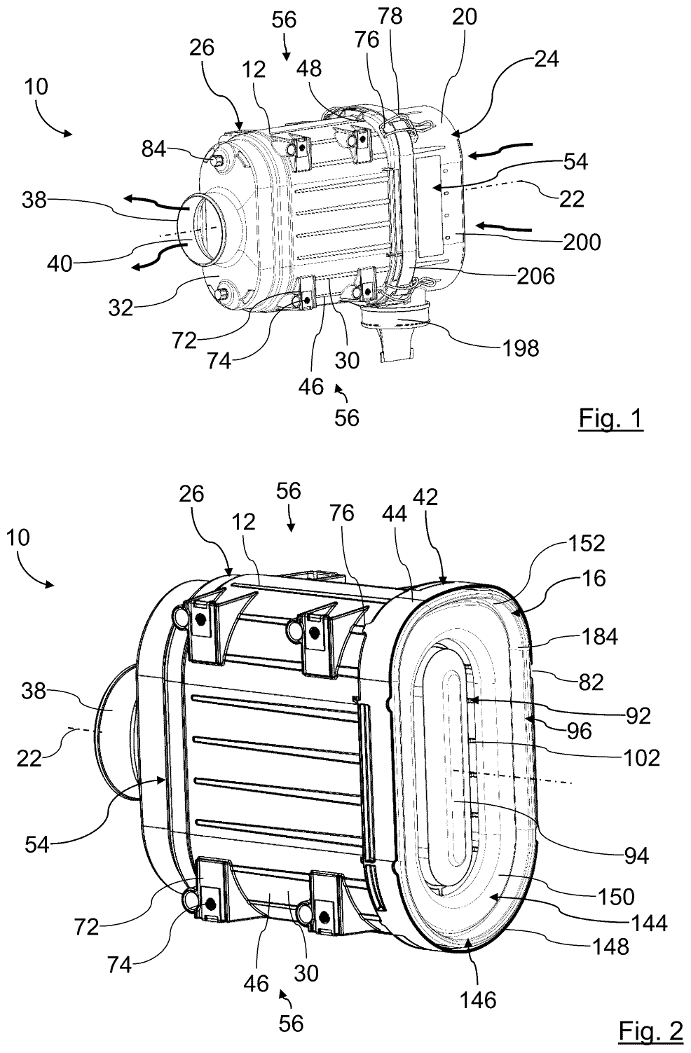

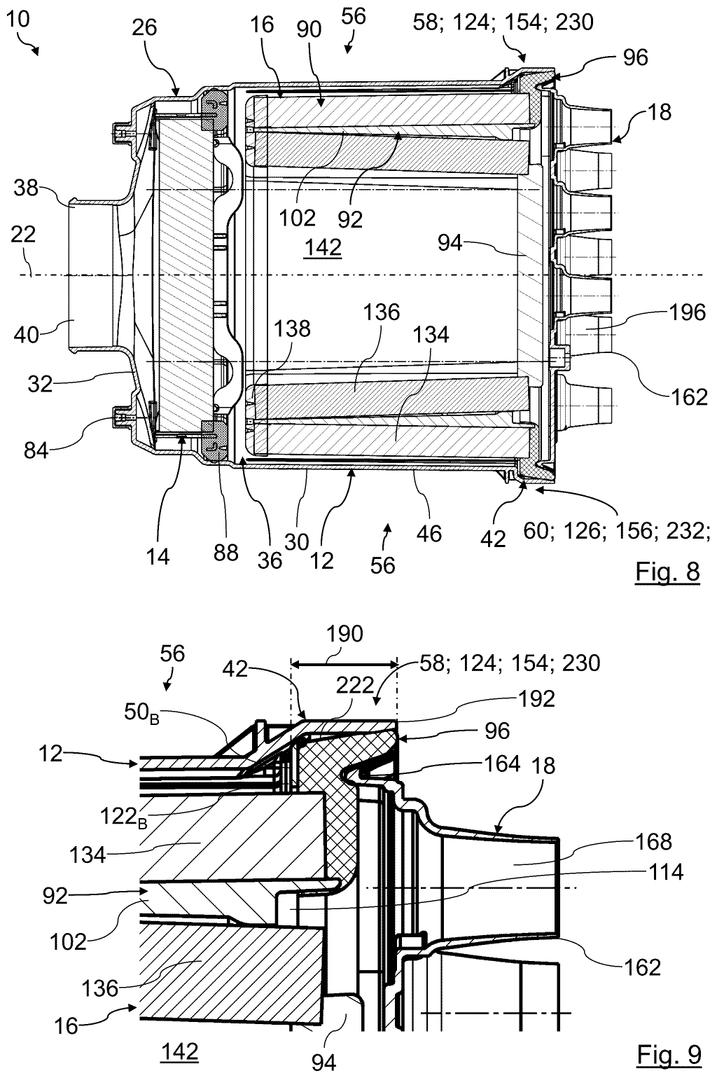

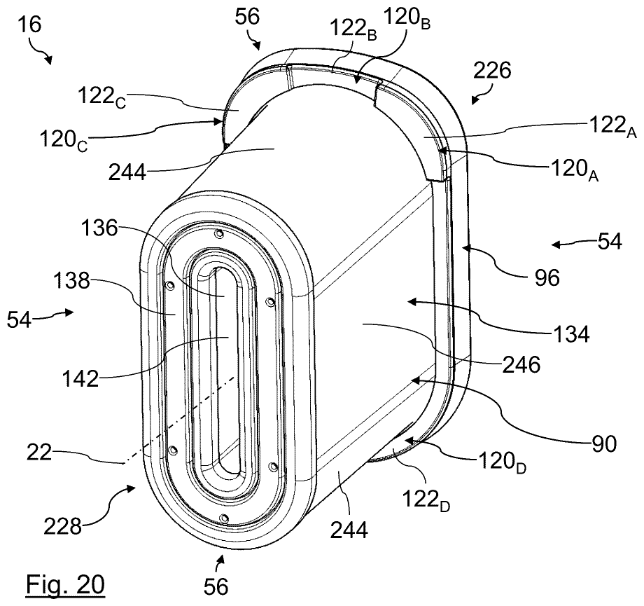

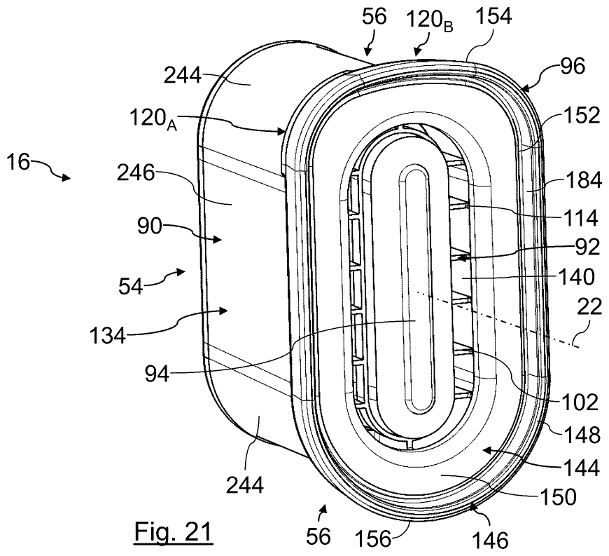

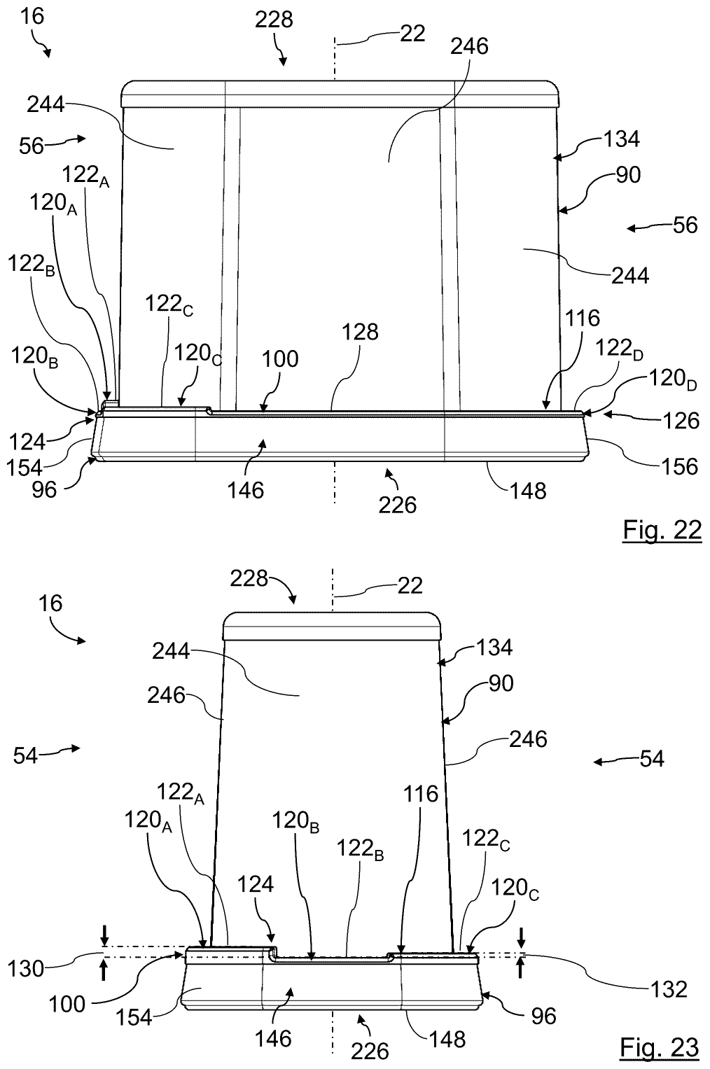

In FIGS. 1 to 23, a filter device 10 for gaseous media and its components are shown in different illustrations. Gaseous media, for example, air, may be freed from solid particles, for example, dust, by means of the filter device 10.

The filter device 10 may be used in vehicles, for example, motor vehicles, in construction and/or agricultural machines, compressors, in connection with internal combustion engines, in cathode filters, for example, in connection with fuel cells, or the like.

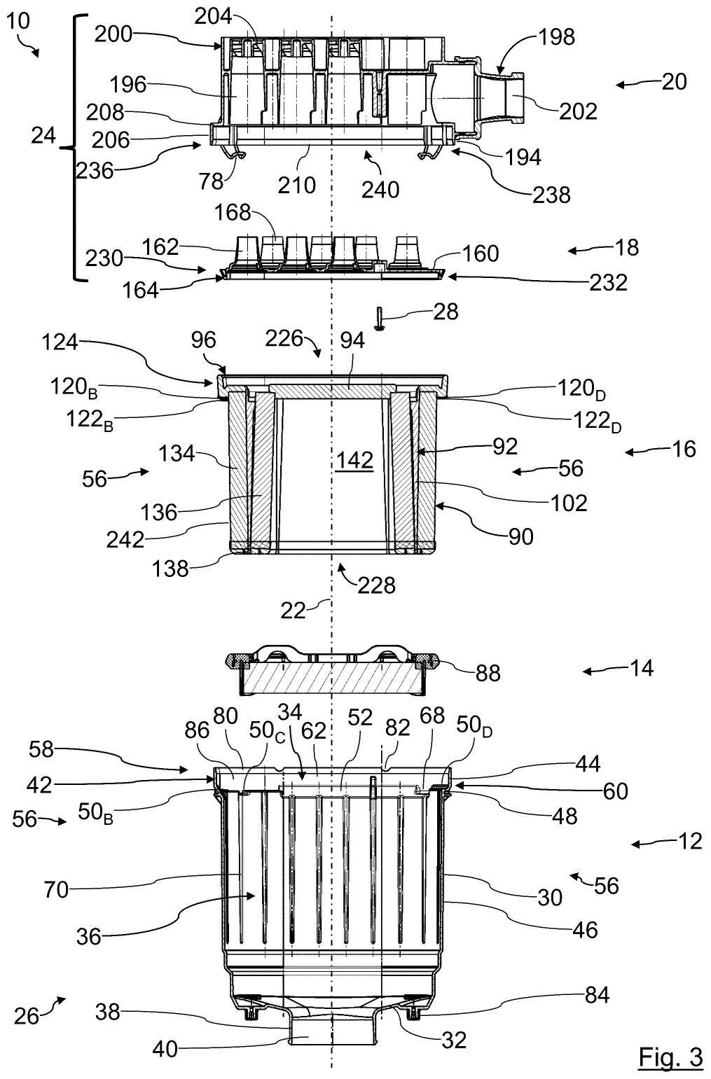

The filter device 10 comprises, as shown, for example, in an exploded illustration in FIG. 3, a housing pot 12, an after filter element 14, a main filter element 16, an immersion tube plate 18, and a cyclone housing 20. The filter device 10 as a whole is axially constructed in relation to an axis 22.

In the following, the components of the filter device 10 and their arrangement relative to each other in relation to the virtual axis 22 will be explained. The axis 22 may coincide with a housing axis of the housing pot 12, an installation/removal axis of the after filter element 14 and of the main filter element 16 in the housing pot 12, respectively, out of the housing pot 12, a connection axis of the immersion tube plate 18 to the housing pot 12, a connection axis of the cyclone housing 20 to the housing pot 12, an element axis of the after filter element 14, an element axis of the main filter element 16, a housing axis of the housing pot 12, a plate axis of the immersion tube plate 18, and a housing axis of the cyclone housing 20. When in the specification “radial”, “coaxial”, “axial”, “tangential”, “circumferential”, “concentric”, “eccentric” or the like is mentioned, this relates to the axis 22, if nothing else is mentioned. In this context, “circumferential” relates to the course of respective virtual wall surfaces which surround the axis 22.

In the connected state, the immersion tube plate 18 and the cyclone housing 20 form the cyclone block 24. On the other hand, the housing pot 12 as a first housing part and the immersion tube plate 18 as a second housing part form a filter housing 26 in the connected state. When the filter device 10 is assembled, the immersion tube plate 18 is connected by means of screws to the cyclone housing 20.

In the following, the housing pot 12 will be explained in more detail with the aid of FIGS. 3 and 12 to 15.

The housing pot 12 is realized as one piece. The housing pot 12 is comprised, for example, of plastic material, for example, a hard plastic material.

The housing pot 12 comprises a housing wall 30 which contiguously surrounds the axis 22. At an axial end face of the housing pot 12, a housing bottom 32 adjoins the housing wall 30. At the side which is axially facing away from the housing bottom 32, the housing wall 30 surrounds a service opening 34.

The housing wall 30 and the housing bottom 32 delimit a filter element receiving space 36 of the housing pot 12. The after filter element 14 and the main filter element 16 are arranged in the filter element receiving space 36, when the filter device 10 is mounted. In this context, the after filter element 14 and the main filter element 16 may be inserted in the filter element receiving space 36 and removed from it through the service opening 34.

An outlet socket 38 is integrated into the housing bottom 32. The outlet socket 38 comprises an outlet opening 40 for purified gaseous medium. The outlet socket 38 extends, for example, axially to the axis 22. For example, the outlet socket 38 has a circular cylindrical shape.

In the region axially adjacent to the housing bottom 32, at the side which is axially facing the service opening 34, the housing wall 30 is stepped twice radially outwardly. As a whole, the housing pot 12 thus tapers in axial direction toward the housing bottom 32. The stepped region forms a receiving region for the after filter element 14. The region of the filter element receiving space 36 located between the stepped region and the service opening 34 serves for receiving the main filter element 16.

Viewed perpendicularly to the axis 22, the housing wall 30 has an elongate oval cross section.

At the axial side with the service opening 34, the housing wall 30 comprises a collar 42 which surrounds the axis 22 contiguously.

Viewed in axial direction, the collar 42 has an elongate oval cross section. The elongate oval cross section of the collar 42 differs however from the elongate oval cross section of the housing wall 30 between the collar 42 and the housing bottom 32. The housing wall 30 is symmetrical in relation to a rotation around the axis 22 by 180° in the region between the housing bottom 32 and the collar 42. In contrast thereto, the collar wall 44 has no rotational symmetries in relation to the axis 22. This will be explained further in more detail in the following.

The collar wall 44 is radially outwardly offset in relation to a main wall section 46 of the housing wall 30. The main wall section 46 extends in axial direction between the collar 42 and the housing bottom 32.

A collar 48 extends between the main wall section 46 and the collar wall 44.

At its axially oriented inner side which faces the filter element receiving space 36, the collar 48 comprises a plurality of contact surfaces 50. The contact surfaces 50 are arranged circumferentially distributed along the collar 48 in respective collar sections of the collar 42. For ease of differentiation, in the following the reference characters of the contact surfaces 50 are provided with the indices A, B, C or D, i.e., 50A, 50B, 50C or 50D.

A ramp surface 52 is arranged between the contact surface 50A and the contact surface 50D. At the radially opposed side between the contact surface 50C and the contact surface 50D, a further ramp surface 52 is arranged. The two ramp surfaces 52 are arranged on radially opposed sides.

The contact surfaces 50 extend in circumferential direction and perpendicularly to the axis 22. The ramp surfaces 52 extend circumferentially and are slanted in relation to the axis 22 in axial direction toward the axis 22, viewed from the service opening 34.

The ramp surfaces 52 of the collar 42 extend along long sides 54 of the filter device 10 which as a whole, viewed in axial direction, is of an elongate oval configuration. Short sides 56 extend between the long sides 54, respectively.

In the following, the reference characters long sides 54 and short sides 56 are used for improved clarity for the components of the filter device 10 which have an elongate oval cross section.

A flatly curved section 58 extends at one of the short sides 56 of the collar wall 44. A circularly curved section 60 of the collar wall 44 extends at the short side 56 which is opposed in relation to the axis 22. The flatly curved section 58 has a larger radius of curvature than the circularly curved section 60. Between the flatly curved section 58 and the circularly curved section 60, a straight connection section 62 of the collar wall 44 extends along the long sides 54, respectively.

In the region of the flatly curved section 58, the three contact surfaces 50A, 50B and 50C are provided. The fourth contact surface 50D is located at the side of the circularly curved section 60. The two lateral contact surfaces 50A and 50C extend respectively from the transition of the respective straight connection section 62 into the flatly curved section 58 all the way to the third contact surface 50B. The third contact surface 50B extends between the lateral contact surfaces 50A and 50C.

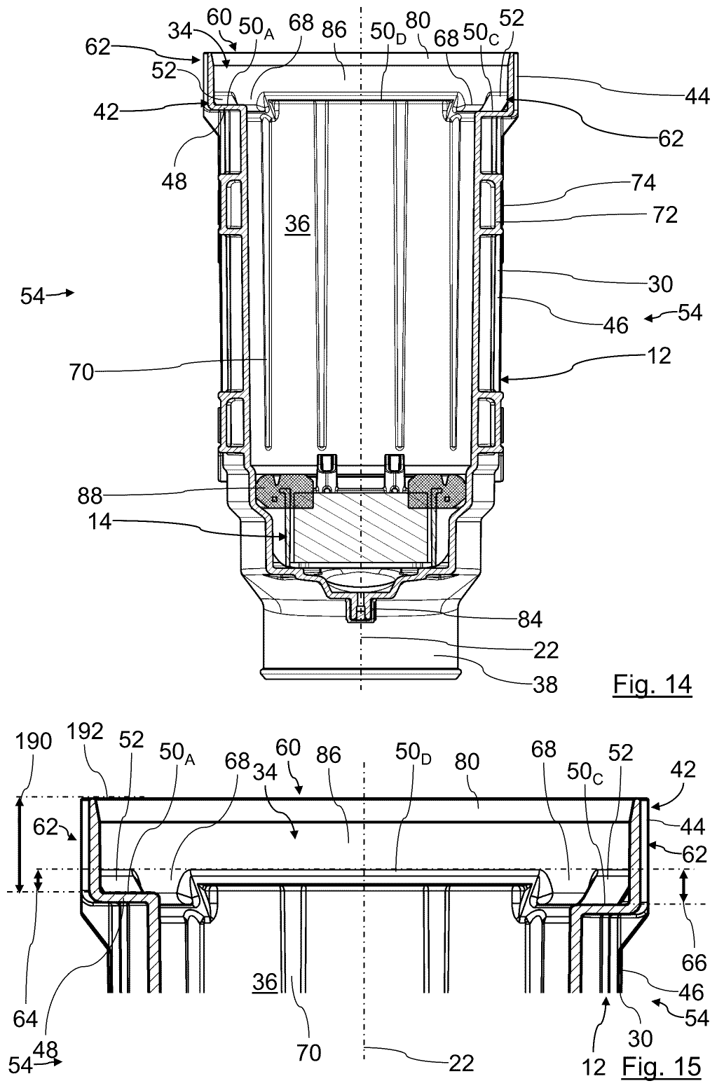

The middle contact surface 50B on the part of the flatly curved section 58 and the contact surface 50D on the part of the circularly curved section 60 are positioned at the same axial height. The contact surfaces 50A, 50B and 50C on the part of the flatly curved section 58 are located, as seen, for example, in FIGS. 14 and 15, at different axial levels. The middle contact surface 50B and the contact surface 50D are located, viewed in axial direction, closer to the free rim of the collar wall 44 than the two outer contact surfaces 50A and 50C. An axial distance 64 between the contact surface 50D and the contact surface 50A is smaller than a distance 66 between the contact surface 50D and the contact surface 50C.

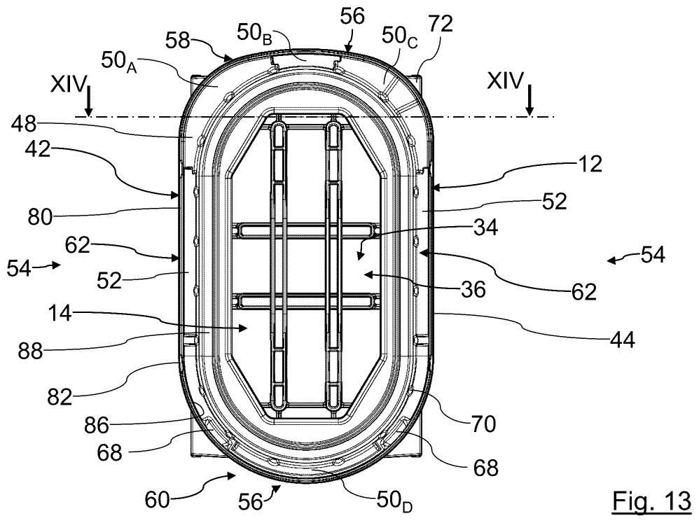

The contact surface 50D extends circumferentially, as seen in FIG. 13, for example, at the center of the circularly curved section 60 on the part of the circularly curved section 60 approximately around a circumferential angle of approximately 90° around a circle center, not shown, of the circularly curved section 60.

Between the contact surface 50D and each one of the neighboring ramp surfaces 52, there is a depression 68, respectively. The depressions 68 extend in axial and radial direction along the collar wall 44, respectively. The ramp surfaces 52 extend along the collar wall 44 from the respective straight connection sections 62 all the way to the respective circularly curved sections 60.

In the main wall section 46 of the housing wall 30, a plurality of grooves 70 extend approximately axially from the collar 48 to a position shortly before the stepped region of the housing wall 30, respectively. The grooves 70 are arranged distributed along the main wall section 46 in circumferential direction. The grooves 70 are each realized as bulges in radial outward direction in the main wall section 46. Each one of the grooves 70 forms an elongate recess at the radially inner side of the main wall section 46. In addition, each one of the grooves 70 forms an elongate protrusion at the radially outer side of the main wall section 46. Depending on the circumferential position, the grooves 70 open toward the contact surfaces 50 or ramp surfaces 52. Viewed in axial direction, the cross sections of the grooves 70 taper toward the housing bottom 32, respectively.

Furthermore, at the radially outer side of the main wall section 46, a total of eight fastening blocks 72 are arranged. Four of the fastening blocks 72 are located in this context at the side of the main wall section 46 which is axially facing the collar 42. The four other fastening blocks 72 are located at the side which is axially facing the stepped region adjacent to the housing bottom 32. At each one of the fastening blocks 72, a screw collar 74 is arranged at the side which is facing the corresponding long side 54. The screw collars 74 are realized as flat metal plates, as an example. The screw collars 74 at a common long side 54 extend in a plane. Each of the screw collars 74 comprises a threaded hole. The axes of the threaded holes of the screw collars 74 extend parallel to each other. By means of the screw collars 74, the filter device 10 may be fastened to corresponding holding elements. The holding elements may be, for example, connected fixedly to the machine at which the filter device 10 is to be used.

Furthermore, at the outer side of the collar 48 which is axially facing away from the collar wall 44, a total of four clamping noses 76 are arranged at the outer side. The clamping noses 76 are projecting in axial extension of the collar wall 44 away from the collar wall 44. Two of the clamping noses 76 are located in the region of the flatly curved section 58 in the vicinity of the transitions of the flatly curved section 58 to the respective neighboring straight connection sections 62. The two other clamping noses 76 are located in the region of the circularly curved section 60 in the vicinity of the transitions to the respective neighboring straight connection section 62. Viewed in axial direction, the clamping noses 76 are aligned respectively with the axially neighboring fastening blocks 72. The clamping noses 76 serve to be engaged by the respective clamping clips 78. The clamping clips 78, as will be explained in more detail in the following, are supported at the cyclone housing 20.

Between the collar 48 and the free rim of the collar wall 44, the collar wall 44 comprises at the radially inner circumferential side an interior wall surface 86 extending in circumferential direction. At the side which is axially facing the free rim of the collar wall 44, the interior wall surface 86 comprises a ramp section 80. In the ramp section 80, the interior wall surface 86 extends at a slant to the axis 22. The radially inner circumference of the collar wall 44 enlarges in the ramp section 80 in axial direction toward the free rim. The ramp section 80 forms thus a funnel-shaped insertion aid for the after filter element 14 and the main filter element 16. Axially between the ramp section 80 and the collar 48, the interior wall surface 86 extends parallel to the axis 22.

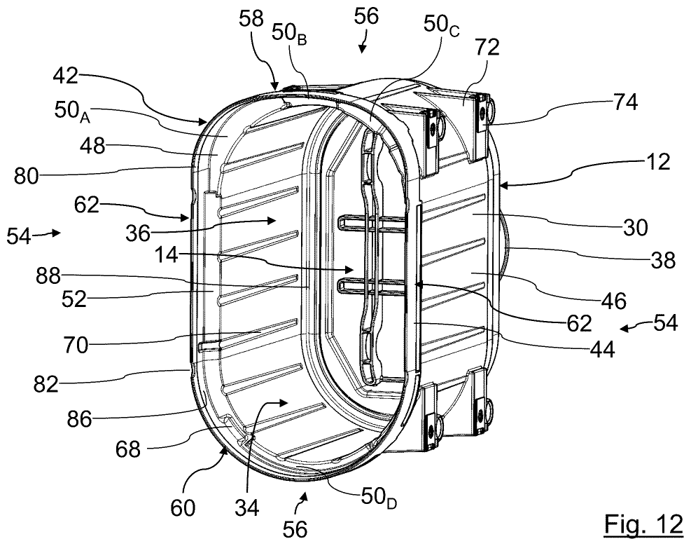

Furthermore, the collar wall 44 comprises four depressions 82, which are seen, for example, in the FIGS. 12 and 13, and which are arranged distributed along the free rim of the collar wall 44. The depressions 82 deepen respectively into the ramp section 80 in axial direction and extend circumferentially as well as in radial direction. Two of the depressions 82 are located respectively at one of the long sides 54 at the corresponding transition between the connection section 62 and the flatly curved section 58. The other two depressions 82 are located at the long sides 54 at the transitions between the respective connection section 62 and the circularly curved section 60.

At the outer side of the housing bottom 32 which is facing away axially from the filter element receiving space 36, two nipples 84 are furthermore arranged. The nipples extend parallel to the axis 22, respectively. The nipples 84 are located on radially opposed sides of the axis 22 adjacent to the short sides 56 of the housing pot 12, respectively.

The after filter element 14 is designed, for example, as a so-called flat filter element. The after filter element 14 serves as a secondary filter element. Viewed in the direction of the axis 22, the radially outer side of the after filter element 14 has an elongate oval shape. The course of the radially outer wall surface of the after filter element 14 corresponds to the elongate oval shape of the radially inner circumferential side of the housing pot 12 in the twice stepped region adjacent to the housing bottom 32. At one of its axial end faces, the after filter element 14 has a seal 88 extending circumferentially in relation to the axis 22. By means of the seal 88, the clean side of the after filter element 14 is separated from the raw side in the installed state.

In the following, the main filter element 16 will be explained in more detail for example with reference to FIGS. 3, 5, and 16 to 23.

The main filter element 16 comprises a filter medium body 90, a skeleton 92, an end member 94, and a seal 96.

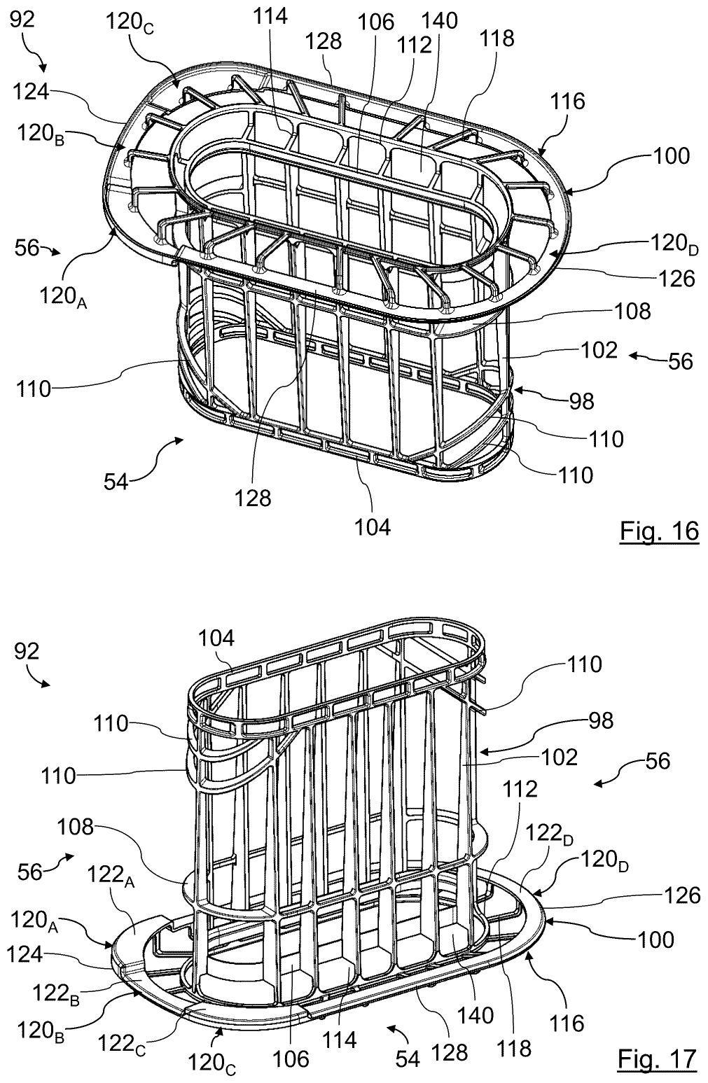

The skeleton 92 is shown in detail in FIGS. 16 to 19. The skeleton 92 as a whole is realized as one piece. For example, the skeleton 92 is manufactured as an injection molded part of hard plastic material.

The skeleton 92 comprises a central element 98 and a frame element 100.

The central element 98 serves as a support element in which filter bellows 134 and 136, which will be explained in more detail in the following, are supported. The central element 98 comprises a plurality of axial stays 102. The axial stays 102 extend each approximately parallel to the axis 22. The axial stays 102 are arranged distributed around the axis 22. At an axial side of the skeleton 92, the ends of the axial stays 102 located there are connected to each other by a connection ring 104.

Viewed in axial direction, the axial stays 102 have an approximately rectangular cross section. The long sides of the rectangular cross section of each axial stay 102 are respectively aligned parallel to a radial direction in relation to the axis 22. The circumferential dimensions of the axial stays 102 in relation to the axis 22, i.e., the expansion of the short sides of the rectangular cross section of the axial stays 102, are constant across their axial length. The radial dimensions of the axial stays 102 in relation to the axis 22, i.e., the expansion of the long sides of the rectangular cross section of the axial stays 102, increases from the end facing the connection ring 104, viewed in axial direction. As a whole, the axial stays 102 in relation to the axis 22 are designed approximately in a wedge shape, viewed in circumferential direction.

The radially outer sides of the axial stays 102 in relation to the axis 22 are slanted toward the axis 22, viewed from the frame element 100 toward the connection ring 104. Thus, a virtual radially outer wall surface surrounding the central element 98 and defined by the radially outer sides of the axial stays 102 comprises a conical shape tapering toward the connection ring 104. The virtual radially inner wall surface which is defined by the axial stays 102 comprises a shape tapering from the connection ring 104 toward the frame 100, viewed axially.

The connection ring 104 has an elongate oval cross section viewed in axial direction. The connection ring 104 comprises two parallel extending coaxial ring sections of the same circumference which are connected to each other by axially extending stays.

The ends of the axial stays 102 which are axially opposed to the connection ring 104 are connected to a radially inner ring 106. The radially inner ring 106 extends, on the one hand, parallel and, on the other hand, coaxially to the connection ring 104. The radially inner ring 106 extends between the radially inner circumferential sides of the ends of the axial stays 102.

Between the radially inner ring 106 and the connection ring 104, an intermediate ring 108 is arranged. The intermediate ring 108 connects the axial stays 102 to each other. The intermediate ring 108 extends, on the one hand, parallel and, on the other hand, coaxially to the connection ring 104 and to the radially inner ring 106. The intermediate ring 108 extends in radial expansion from the radially inner circumferential sides of the axial stays 102 to the radially outer circumferential sides. The intermediate ring 108 is positioned at an axial distance to the radially inner ring 106 which corresponds to approximately a third of the axial distance between the radially inner ring 106 and the connection ring 104.

Two connection arcs 110 extend at the short sides 56, respectively. Each of the connection arcs 110 is connected with its free ends to the connection ring 104. In the curved center, each of the connection arcs 110 is connected to a central axial stay 102. The connection arcs 110 each extend from the connection ring 104 at the side which is axially facing the frame element 100 at a slant to the axis 22 in the direction toward the central axial stay 102. At each short side 56, one of the connection arcs 110 is connected, at an axial distance in relation to the connection ring 104, to the central axial stay 102, which distance approximately amounts to about one fifth of the axial distance between the frame element 100 and the connection ring 104. This connection arc 110 connects the connection ring 104 to the central axial stay 102. The other connection arc 110 at the short side 56 is connected, at an axial distance in relation to the connection ring 104, to the central axial stay 102, which distance corresponds to approximately one fourth of the axial distance between the frame element 100 and connection ring 104. The latter connection arc 110 connects the connection ring 104 to the central axial stay 102 and the two axial stays neighboring the central axial stay 102 at the short sides 56.

At their wide end in radial direction, the axial stays 102 comprise at the radially outer side a step which rises in axial direction. The steps of the axial stays 102 are connected to an outer ring 112.

The radially outer ring 112 has an elongate oval cross section. The radially outer ring 112 extends coaxially to the axis 22. The radially outer ring 112 is axially spaced apart from the radially inner ring 106. This is achieved by the steps.

At the ends of the axial stays 102, respective connection openings 114 are realized between the outer ring 112 and the radially inner ring 106. The connection openings 114 comprise the axial height of the steps at the ends of the axial stays 102. By means of the connection openings 114, axially extending flow spaces 140 which are located between two neighboring axial stays 102 are connected to each other at the level of the radially inner ring 106.

The radially outer ring 112 is surrounded by a support ring 116 of the frame element 100. The support ring 116 extends coaxially to the axis 22. The support ring 116 comprises an elongate oval cross section which differs from the elongate oval cross section of the radially outer ring 112, of the radially inner ring 106, and of the connection ring 104, as will be explained in more detail in the following.

The support ring 116 is connected by means of radially extending radial stays 118 to the radially outer ring 112. The radial stays 118 comprise at the side which is facing the support ring 116 a bend by approximately 90°, respectively, in the direction toward the connection ring 104. The ends of the radial stays 118 behind the bend engage respectively at the side of the support ring 116 which is axially facing away from the connection ring 104.

The support ring 116 comprises four support sections 120 which are seen, for example, in FIGS. 17 to 19. The reference characters of the support sections 120 are identified with the indices A, B, C, and D for better differentiation.

The sides of the support sections 120 axially facing the connection ring 104 form each a support surface 122. The reference characters of the support surfaces 122, like the reference characters of the respective support sections 120, are provided with the indices A, B, C, and D for better differentiation. The support surfaces 122 each are planar. The planes of the support surfaces 122 extend perpendicularly to the axis 22, respectively.

As a whole, the frame element 100 extends radially inwardly, beginning at the support sections 120, and in the direction toward an inflow side 226 of the main filter element 16.

The cross section of the radially outer circumferential side of the support ring 116 corresponds in its shape to the cross section of the radially inner circumferential side of the collar wall 44 of the housing pot 12. The radially outer circumference of the support ring 116 is somewhat smaller than the radially inner circumference of the collar wall 44.

The support ring 116 comprises a flatly curved section 124 at the radial exterior wall surface and a circularly curved section 126. The flatly curved section 124 and the circularly curved section 126 are connected to each other by two opposed straight connection sections 128. The radius of curvature of the flatly curved section 124 is larger than the radius of curvature of the circularly curved section 126. As a whole, thus the support ring 116 and therefore also the radially outer wall side of the frame element 100 does not have rotational symmetry in relation to the axis 22.

The central support section 120B with the central support surface 122B extends at the center of the flatly curved section 124 between the two outer support sections 120A and 120C with the corresponding outer support surfaces 122A and 122C. The support sections 120A and 120C with their respective support surfaces 122A and 122C extend between the respective straight connection sections 128. The circumferential extension of the two lateral support sections 120A and 120C corresponds to the circumferential extension of the two lateral contact surfaces 50A and 50C of the housing pot 12.

The support section 120D with its support surface 122D extends at the side radially opposed to the central support section 120B centrally in the circularly curved section 126. The circumferential extension of the support section 120D and the support surface 122D is larger than the circumferential extension of the contact surface 50D of the housing pot 12.

The support section 120D with the support surface 122D passes without a step into the respective neighboring straight connection sections 128 of the support ring 116.

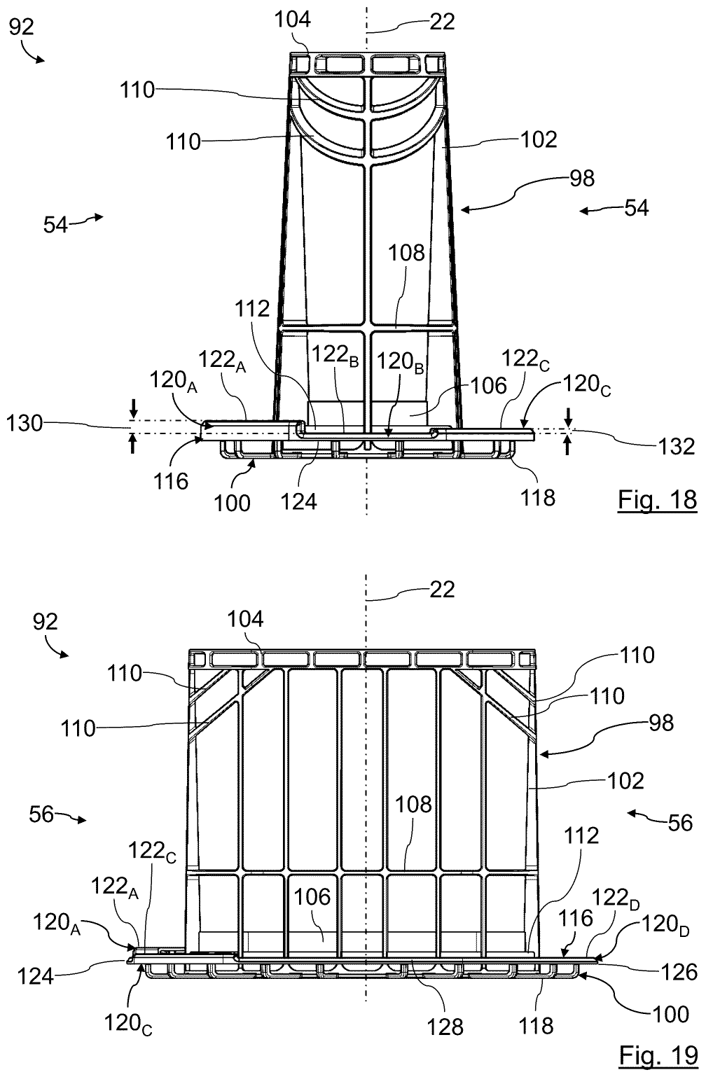

The central support surface 122B and the central support surface 122D are located at the same axial height. In relation to the central support surface 122B, the outer support surface 122A is located at the side of the support ring 116 facing the connection ring 104 at an axial distance 130, which is identified, for example, in FIG. 18. The other outer support surface 122C is located at the side of the support ring 116 facing the connection ring 104 at an axial distance 132 in relation to the central support surface 122B. The distance 130 of the outer support surface 122A is larger than the distance 132 of the outer support surface 122C. The distance 130 of the outer support surface 122A corresponds to the distance 66 of the outer support surface 50A of the housing pot 12. The distance 132 of the outer support surface 122C corresponds to the distance 64 of the outer contact surface 50C of the housing pot 12.

As a whole, the side of the support ring 116 which is facing axially the connection ring 104 in the region of the support sections 120 is complementary to the side of the collar 48 of the housing pot 12 which is axially facing away from the housing bottom 32.

The filter medium body 90 comprises, as shown in FIG. 3, for example, an outer filter bellows 134 and an inner filter bellows 136. The filter bellows 134 and 136 are comprised each of folded filter media, for example, filter nonwoven.

The outer filter bellows 134 has the shape of a hollow truncated cone with elongate oval base surface. The outer filter bellows 134 is coaxial to the axis 22. The base surface of the outer filter bellows 134 is located at the side of the main filter element 16 where also the frame element 100 of the skeleton 92 is located. The radially inner wall side of the outer filter bellows 134 extends parallel to its radially outer wall side. The folds of the folded outer filter bellows 134 extend in axial direction, respectively. The folds define the respective wall side.

The radially outer wall surface of the outer filter bellows 134 forms a radially outer exterior wall surface 242 of the filter medium body 90. The radially outer exterior wall surface 242 of the filter medium body 90 comprises, in relation to its course surrounding the axis 22, two curved sections 244 and two straight connection sections 246. The curved sections 244 are located at radially opposed sides at the short sides 56. The connection sections 246 are located at radially opposed sides at the long sides 54. The curved sections 244 are connected by the straight connection sections 246.

The radial thickness of the outer filter bellows 134 is defined by the fold height. The radial thickness of the outer filter bellows 134 correspond approximately to the radial distance of the support ring 116 of the frame element 100 of the skeleton 92 to the radially outer ring 112 and to the radially outer sides of the axial stays 102.

The radially outer circumference and the radially inner circumference of the outer filter bellows 134 decrease respectively in axial direction away from the frame element 100 of the skeleton 92 toward the connection ring 104. The outer filter bellows 134 tapers, viewed in axial direction, from the frame element 100 toward the connection ring 104.

The radially inner wall side of the outer filter bellows 134 is supported at the respective radially outer sides of the axial stays 102, of the intermediate ring 108, and of the connection arcs 110 of the skeleton 92.

The inner filter bellows 136 has the shape of a hollow truncated cone with elongate oval base surface. The inner filter bellows 136 is coaxial to the axis 22. The base surface of the inner filter bellows 136 is located at the side of the main filter element 16 where also the connection ring 104 of the skeleton 92 is located. The radially inner wall side of the inner filter bellows 136 extends parallel to its radially outer wall side. The folds of the folded inner filter bellows 136 extend respectively in axial direction. The folds define the respective wall side.

The radial thickness of the inner filter bellows 136 is defined by the fold height. The radial thickness of the inner filter bellows 136 corresponds approximately to the radial thickness of the outer filter bellows 134.

The radially outer circumference and the radially inner circumference of the inner filter bellows 136 decrease respectively in axial direction away from the connection ring 104 of the skeleton 92 toward the frame element 100. Viewed in axial direction, the inner filter bellows 136 tapers from the connection ring 104 toward the frame element 100.

The radially outer wall side of the inner filter bellows 136 is supported at the respective radially inner sides of the axial stays 102, of the intermediate ring 108, of the radially inner ring 106, and of the connection arcs 110 of the skeleton 92.

The circumference of the radially outer wall side of the inner filter bellows 136 in the region of the base surface is somewhat smaller than the circumference of the radially inner wall side of the outer filter bellows 134 in the region of the cover side. The inner filter bellows 136 is coaxially arranged in an interior enclosed by the outer filter bellows 134.

At the side of the connection ring 104 of the skeleton 92, the base side of the outer filter bellows 134 is connected by a circumferentially and radially extending connection fold 138 to the base side of the inner filter bellows 136.

Between the radially outer circumferential side of the inner filter bellows 136 and the radially inner circumferential side of the outer filter bellows 134, the flow spaces 140 are realized. Circumferentially, each of the flow spaces is delimited by one of two neighboring axial stays 102. Gas to be purified flows into the flow spaces 140. From the flow spaces 140, the gas to be purified flows functionally parallel through the outer filter bellows 134 from the interior to the exterior in radial direction and through the inner filter bellows 136 from the exterior to the interior in radial direction.

The end member 94 closes off an element interior 42 surrounded by the inner filter bellows 136 at the axial end face which is facing the frame element 100. The end member 94 is arranged coaxially to the axis 22. The end member 94 has an elongate oval cross section. The end member 94 is connected circumferentially in relation to the axis 22 to the radially inner ring 106 of the skeleton 92 and is supported by the latter. The end member 94 is made, for example, of elastic material, for example, elastomer.

In the following, the seal 96 which is shown in detail in FIG. 5 will be explained in more detail. The seal 96 is annular and has an elongate oval extension viewed in axial direction. The seal 96 is manufactured as one piece from an elastic material, for example, elastomer. The material of the seal 96 is softer than the material from which the skeleton 92 with the frame element 100 is formed.

The seal 96 comprises a holding section 144 and a seal section 146.

By means of the holding section 144, the seal 96 is connected to the frame element 100 of the skeleton 92. In this context, the seal 96 with the holding section 144 may be glued or molded to the side of the frame element 100 which is facing axially away from the connection ring 104. The holding section 144 surrounds at the respective radially inner side the radially outer ring 112 of the skeleton 92 and the steps at the ends of the axial stays 102 at their radially outer sides. The frame element 100 is embedded thereat in sections by the material of the seal 96.

The holding section 144 leaves exposed the support surfaces 122 at the side of the support ring 116 which is axially facing the connection ring 104.

The holding section 144 extends past the radially outer ring 112 of the skeleton 92 radially outwardly and passes in the region of the radially outer side of the support ring 116 into the seal section 146.

The seal section 146 is arranged immediately adjacent, in relation to the axis 22, to the radially outer wall surface of the support ring 116 and thus of the frame element 100. In addition, the seal section 146 is arranged completely radially outside, in relation to the axis 22, of the radially outer wall surface of the filter medium body 90.

A free side 150 of the holding section 144 at the side of the holding section 144 facing away from the frame element of the skeleton 92 extends in a plane perpendicular to the axis 22.

The seal section 146 is a seal stay. The seal section 146 extends away from the support ring 116 in axial direction. The free end of the seal section 146 extends in a virtual plane perpendicularly to the axis 22. The axial free end 148 of the seal section 146 projects past the side 150 of the holding section 144 facing away from the skeleton 92 in axial direction. The radially outer circumference of the seal section 146 in the region of its free end 148 is somewhat larger than the radially outer circumference of the seal section 146 in the region of the support ring 116. Correspondingly, the radially inner circumference of the seal section 146 in the region of the free end 148 is larger than the radially inner circumference of the seal section 146 in the region of the transition to the holding section 144. The seal section 146 tapers conically in axial direction from the free end 148 toward the support ring 116.

The seal section 146 is radially outwardly offset in relation to the radially outer exterior wall surface 242 of the filter medium 90.

When the seal 96 is relaxed, as illustrated, for example, in FIG. 11, an axial distance 188 between the respective section surface 122 of the frame element 100 of the skeleton 92 and the free end 148 of the seal 96 is larger than an axial distance 190 between the corresponding contact surface 50 of the collar 48 of the housing pot 12 and a free rim 192 of the collar wall 44.

At the transition of the holding section 144 to the seal section 146, a recess 152 is located. The recess 152 extends in relation to the axis 22 circumferentially along the radially inner side of the seal section 146 at the side 150 of the holding section 144 facing axially away from the support ring 116.

Viewed in axial direction, the seal section 146 has an elongate oval course. The course of the seal section 146 corresponds to the course of the collar wall 44 of the housing pot 12 and of the frame element 100 of the skeleton 92, viewed in axial direction.

The seal section 146 comprises at the short side 56 a flatly curved section 154 and at the opposed short side 56 a circularly curved section 156. The flatly curved section 154 has a larger radius of curvature than the circularly curved section 156. The flatly curved section 154 and the circularly curved section 156 are connected at the long sides 54 by a straight connection section 158, respectively.

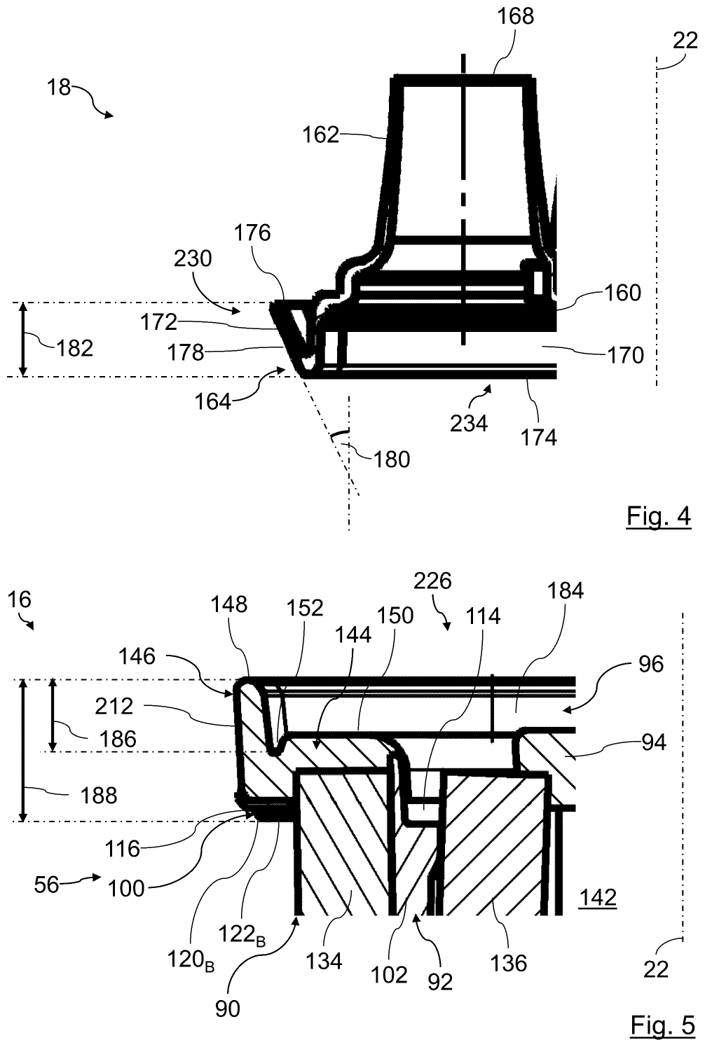

The immersion tube plate 18 will be explained in the following with the aid of FIGS. 3 and 4 in more detail.

The immersion tube plate 18 is realized as one piece. The immersion tube plate 18 is comprised of plastic material, for example, an injection moldable hard plastic material. For example, the immersion tube plate 18 is produced by an injection molding method.

The immersion tube plate 18 comprises a plate section 160, a plurality of immersion tubes 162, and a rib 164.

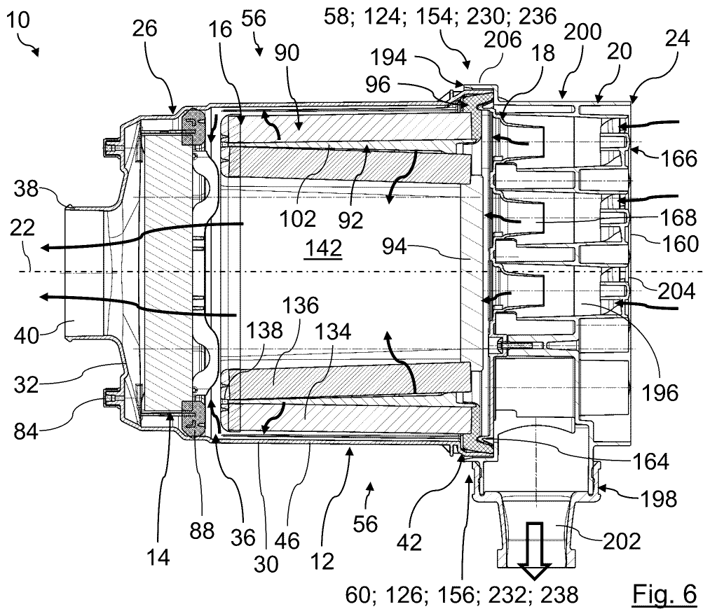

The plate section 160 extends in a plane perpendicular to the axis 22. In the plate section 160, a plurality of immersion tubes 162 are arranged in distribution. Each of the immersion tubes 162 is part of a cyclone separator 166. In FIG. 6, for example, some of the cyclone separators 166 are illustrated. The cyclone separators 166 are designed as axial cyclones, for example. The immersion tube plate 18 with the immersion tubes 162 forms together with the cyclone housing 20 the cyclone block 24. The cyclone block 24 comprises a plurality of cyclone separators 166.

Each one of the immersion tubes 162 has approximately the shape of a hollow truncated circular cylinder whose axes extend parallel to the axis 22. The base surfaces of the truncated circular cylinders of the immersion tubes 162 are located at the side of the plate section 160. The immersion tubes 162 taper, viewed in axial direction, away from the plate section 160. The interiors of the immersion tubes 162 serve as inlet openings 168 for the gas to be purified.

At its radially outer rim, the plate section 160 passes into the rib 164. In FIG. 4, the rib 164 is illustrated in detail. The rib 164 extends circumferentially contiguously coaxially to the axis 22. The rib 164 has as a whole an approximately V-shaped profile.

One of the legs of the V-shaped rib 164 which in the following is referred to as axial leg 170 is connected to the rim of the plate section 160. The axial leg 170 is located at the radially inner side of the rib 164. The axial leg 170 extends, at least in the relaxed state, for example, when the immersion tube plate 18 is not mounted, axially approximately parallel to the axis 22 and circumferentially.

The other leg of the “V” which in the following is referred to as ramp leg 172 is connected at the side of the axial leg 170, axially facing away from the plate section 160, to the latter. The connection rim of the axial leg 170 with the ramp leg 172, i.e., the closed side of the “V”, is referred to in the following as rib rim 174. The ramp leg 172 is located at the radially outer side of the rib 164. The ramp leg 172 extends radially outwardly at a slant to the axis 22 away from the rib rim 174 at the side which is axially facing the plate section 160. The free end of the ramp leg 172 is referred to as free rim 176.

The radially outer side of the ramp leg 172 forms a contact surface 178. When the filter device 10 is mounted, the contact surface 178 is positioned at the seal section 146 of the seal 96 of the main filter element 16, as will be explained in further detail below. The contact surface 178 extends at a slant to the axis 22 and circumferentially. The contact surface 178 extends at an acute angle 180 in relation to the axis 22. The angle 180 may amount to approximately between 30° and 45°, for example.

An axial distance 182 between the free rim 176 and the rib rim 174 is approximately of the same size as an axial distance between the rib rim 174 and the plate section 160.

Viewed in axial direction, the rib 164 has an elongate oval course. The course of the rib 164 corresponds to the course of the collar wall 44 of the housing pot 12, of the frame element 100 of the skeleton 92, and of the seal section 146 of the seal 96, viewed in axial direction.

The rib 164 comprises at the short side 56 a flatly curved section 230 and at the opposed short side 56 a circularly curved section 232. The flatly curved section 230 has a larger radius of curvature than the circularly curved section 232. The flatly curved section 230 and the circularly curved section 232 are connected at the long sides 54 by a straight connection section 234, respectively.

The circumference of the rib rim 174 corresponds to the circumference of the recess 152 of the seal 96. The acute angle 180 of the contact surface 178 is larger than an angle between a radially inner seal surface 184 of the seal section 146 of the seal 96 and the axis 22 when the seal 96 is relaxed, for example, is in an unmounted state. The axial distance 182 between the rib rim 174 and the free rim 176 of the rib 164 corresponds approximately to an axial distance 186 at the seal 96 between the base of the recess 152 and the free end 148 of the seal section 146.

The cyclone housing 20 will be explained in more detail in the following with the aid of FIGS. 3, 6, and 7.

The cyclone housing 20 comprises a fastening frame 194, a plurality of separation chambers 196, and a particle discharge device 198 and a total of four clamping clips 78.

The separation chambers 196 are located in a main part 200 of the cyclone housing 20. Each one of the separation chambers 196 is correlated with one of the immersion tubes 162 of the immersion tube plate 18. The immersion tubes 162 with the corresponding separation chamber 196 form one of the cyclone separators 166, respectively. The separation chambers 196 have each an approximately circular cylindrical shape. The axes of the separation chambers 196 extend parallel to the axis 22. The axes of the separation chambers 196 extend coaxially to axes of the corresponding immersion tubes 162 when the device 10 is mounted.

The particle discharge device 198 is arranged at a radially outer side of the main part 200. The separation chambers 196 are connected in fluid communication to the particle discharge device 198 in a manner not of interest in this context. In this manner, the particles, for example, dust particles, which have been separated in the respective cyclone separator 166 from the gaseous medium to be purified may reach the particle discharge device 198.

The particle discharge device 198 has a discharge opening 202. The discharge opening 202 is closed during regular operation of the filter device 10. The discharge opening 202 may be opened for discharging the particles collected in the particle discharge device 198. In the mounting orientation of the filter device 10 illustrated in FIG. 1, for example, the particle discharge device 198 is arranged spatially at the bottom at the cyclone housing 20. The discharge opening 202 is thus oriented spatially downwardly.

The fastening frame 194 is located at an axial end face of the main part 200. At the side of the main part 200 axially arranged opposite the fastening frame 194, each of the separation chambers 196 comprises an inlet opening 204 for the gas to be purified. At the side which is axially facing the fastening frame 194, each of the separation chambers 196 comprises an opening for the corresponding immersion tube 162.

The fastening frame 194 comprises an outer frame wall 206 which is connected by a collar 208 to the main part 200.

The outer frame wall 206 and the collar 208 extend circumferentially contiguously around the axis 22.

The collar 208 extends in radial direction away from the main part 200 in radially outward direction. The outer frame wall 206 extends in axial direction away from the collar 208 away from the main part 200.

In the region of its free rim facing axially away from the main part 200, the outer frame wall 206 comprises a guide ramp 210 at the radially inner circumferential side. In the region of the guide ramp 210, the radially inner circumference of the outer frame wall 206 becomes larger in axial direction away from the main part 200 toward the free rim. The circumferential course of the outer frame wall 206 around the axis 22 corresponds to the circumferential course of the collar 42 of the housing pot 12.

Viewed in axial direction, the outer frame wall 206 has an elongate oval course. The course of the outer frame wall 206 corresponds to the course of the collar wall 44 of the housing pot 12, of the frame element 100 of the skeleton 92, of the seal section 146 of the seal 96, and of the rib 164 of the immersion tube plate 18, viewed in axial direction.

The outer frame wall 206 comprises at the short side 56 a flatly curved section 236 and at the opposed short side 56 a circularly curved section 238. The flatly curved section 236 has a larger radius of curvature than the circularly curved section 238. The flatly curved section 236 and the circularly curved section 238 are connected at the long sides 54 by a straight connection section 240, respectively.

The radially inner circumference of the outer frame wall 206 in the region axially between the guide ramp 210 and the main part 200 is somewhat larger than the radially outer circumference of the collar 42 of the housing pot 12.

The radially outer side of the main part 200 has an elongate oval course, viewed in axial direction. In this context, the curved sections at the short sides 56 have the same radius of curvature. Thus, the elongate oval course of the main part 200 differs from the elongate oval course of the outer frame wall 206. The radially outer circumference of the main part 200 corresponds approximately to the radially outer circumference of the main wall section 46 of the housing pot 12.

Two of the clamping clips 78 are located at the side of the flatly curved section 236 in the region of the transition to the corresponding straight connection section 240, respectively. The two other clamping clips 78 are located at the side of the circularly curved section 238 in the region of the transition to the corresponding straight connection section 240, respectively.

The clamping clips 78 engage respectively in the region of the outer side of the collar 208 facing away axially from the outer frame wall 206. The clamping clips 78 extend past the free rim of the outer frame wall 206. The clamping clips 78 are spring clips, for example.

A method for assembly of the filter device 10 will be explained in the following.

First, the immersion tube plate 18 is connected to the cyclone housing 20. For this purpose, the immersion tube plate 18 with the immersion tubes 162 leading is advanced in axial direction into the fastening frame 194. In this context, it may be required to rotate the immersion tube plate 18 and the cyclone housing 20 relative to each other around the axis 22 such that the flatly curved section 236 of the outer frame wall 206 coincides with the flatly curved section 230 of the rib 164, on the one hand, and the circularly curved section 238 of the fastening frame 194 and the circularly curved section 232 of the rib 164 coincide. Upon assembly, the immersion tubes 162 are arranged in one of the separation chambers 196, respectively. Subsequently, the immersion tube plate 18 is fixed with screws 28 to the cyclone housing 20. In case of a future exchange of the main filter element 16 and/or of the after filter element 14 from the filter device 10, the immersion tube plate 18 may remain at the cyclone housing 20. In this way, the entire cyclone block 24 may be separated from the housing pot 12.

The after filter element 14, with its side which facing away from the seal 88 leading, is inserted in axial direction through the service opening 34 into the housing pot 12. In this context, it may be required to rotate the housing pot 12 and the after filter element 14 relative to each other around the axis 22 such that the long sides 54 of the after filter element 14 coincide with the long sides 54 of the housing pot 12 and the short sides 56 of the after filter element 14 with the short sides 56 of the housing pot 12. The after filter element 14 is placed in the stepped section of the housing wall 30 axially adjacent to the housing bottom 32.

Subsequently, the main filter element 16, with its side axially facing away from the seal 96 leading, is inserted in axial direction through the service opening 34 into the filter element interior 36 of the housing pot 12. For this purpose, it may be required to rotate the housing pot 12 and the main filter element 16 relative to each other in relation to the axis 22 such that the short side 56 of the main filter element 16 with the flatly curved section 124 of the frame element 100 of the skeleton 92 and the flatly curved section 154 of the seal 88 coincides with the short side 56 of the housing pot 12 with the flatly curved section 58 of the collar wall 44.

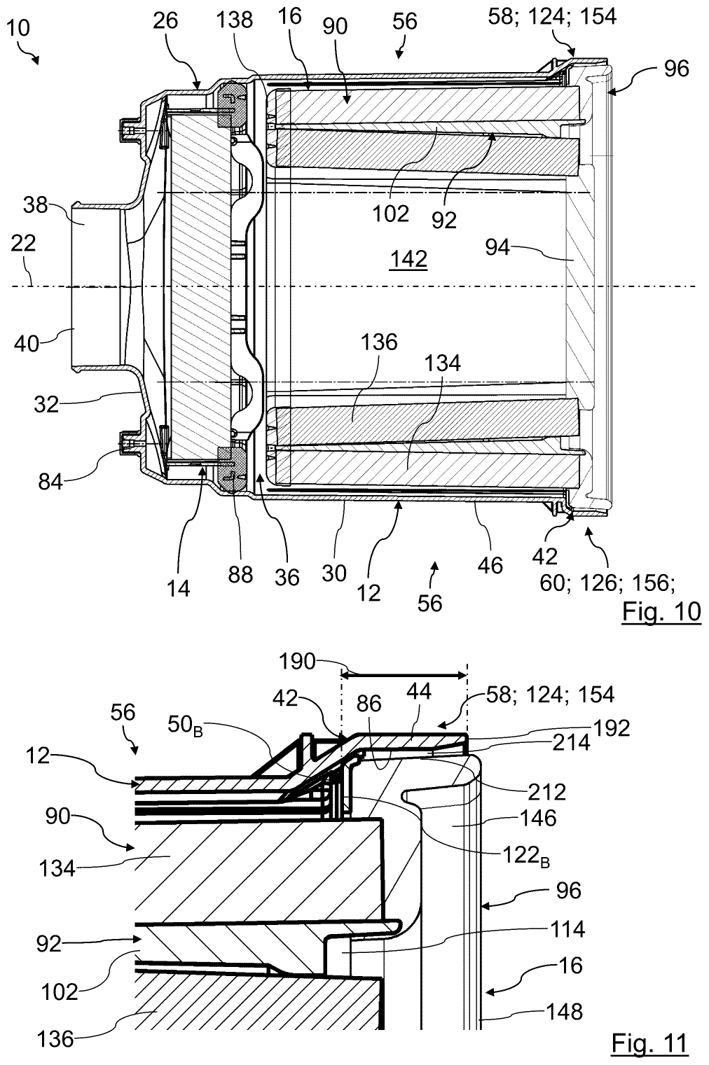

The main filter element 16 is inserted in axial direction so far into the housing pot 12 that the support surfaces 122 of the skeleton 92 contact axially the corresponding contact surfaces 50 of the collar 42. This mounting phase is illustrated in FIGS. 10 and 11. In this mounting phase, the radially outer wall surface 212 of the seal section 146 is spaced apart in radial direction from the interior wall surface 86 of the collar wall 44 of the collar 42 of the housing pot 12. Between the radial outer wall surface 212 of the seal 96 and the interior wall surface 86 of the collar 42, there remains a radial gap 214. The radial gap 214 extends in relation to the axis 22 circumferentially and in axial direction across the entire axial expansion of the interior wall surface 86. In the mounted state illustrated in FIGS. 10 and 11, the free end 148 of the seal section 146 projects in axial direction past the free rim 192 of the collar wall 44 of the housing pot 12.

Subsequently, the cyclone block 24 with the immersion tube plate 18 leading is pushed in axial direction onto the collar 42 of the housing pot 12. In this context, it may be required to rotate the housing pot 12 and the cyclone block 24 around the axis 22 such that the short side 56 of the collar wall 44 with the flatly curved section 58 coincides with the short side 56 of the outer frame wall 206 of the cyclone housing 20 with the flatly curved section 236 and, correspondingly, the short side 56 of the collar wall 44 with the circularly curved section 60 coincides with the short side 56 of the outer frame wall 206 with the circularly curved section 238.

Upon axially pushing on, first the free rim 192 of the collar wall 44 is guided along the radially inner side of the guide ramp 210 of the outer frame wall 206 of the cyclone housing 20 and is thus centered within the fastening frame 194. Upon further insertion of the immersion tube plate 18, the radially outer side of the ramp leg 172 of the rib 164 glides along the radially inner seal surface 184 of the seal 96. Because the ramp leg 172 has a larger slant angle in relation to the axis 22 than the radially inner seal surface 184 of the seal 96, the rib 164 pushes the seal section 146 radially outwardly against the interior wall surface 86.

Upon further insertion, the rib rim 174 of the rib 164 is immersed into the recess 152 of the seal 96. Furthermore, the collar 208 of the cyclone housing 20 presses in axial direction against the free end 148 of the seal section 146. In this way, the seal section 146 is compressed in axial direction and deformed. The material of the seal section 146 yields to the axial compression in radial direction. In this way, an additional increase of a radially acting contact pressure is provided with which the seal section 146 is pressed against the interior wall surface 86 of the collar wall 44.

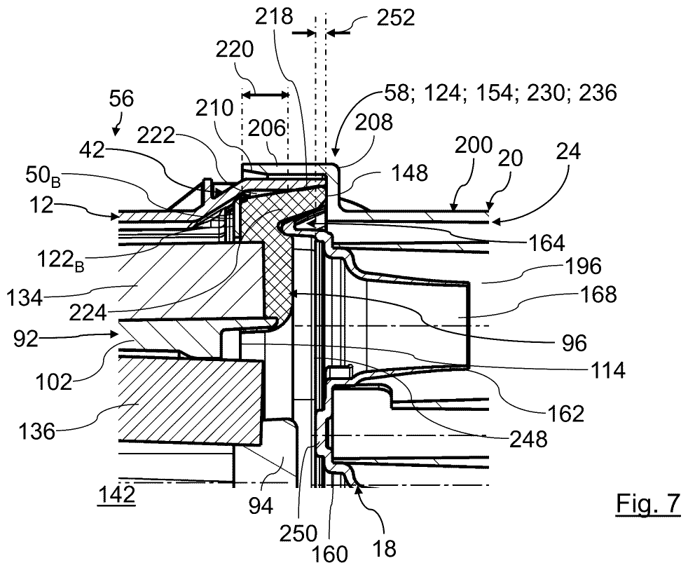

The free ends of the clamping clips 78 are hooked behind the respective engagement sections 76, as shown in FIG. 1. Subsequently, the clamping clips 78 are clamped. In this way, the cyclone block 24 is pushed strongly in axial direction against the collar 42. The axial movement is limited in that the free rim 192 of the collar wall 44 of the housing pot 12 is supported in axial direction at the collar 208 of the cyclone housing 20, as illustrated in FIGS. 6 and 7.

In the finish-mounted position illustrated in FIGS. 1, 6 and 7, the radially outer wall surface 212 of the seal 96 seal-tightly rests in a contact section 218 at the interior wall surface 86 of the collar 42 of the housing pot 12. The contact section 218 begins at an axial distance 220 in relation to the frame element 100 of the skeleton 92, for example in relation to the respective contact surface 50, and extends in an axial direction to the free rim of the collar wall 44. Between the frame element 100 and the beginning of the contact section 218, there remains a residual gap 222 between the radially outer circumferential side of the seal section 146 and the interior wall surface 86 of the collar wall 44. The residual gap 222 extends circumferentially contiguously and in axial direction. The residual gap 222 has a wedge-shaped profile which decreases toward the contact section 218 in axial direction.

Each immersion tube 162 comprises an outflow end 248 at its side facing the inflow side 226 of the filter element 16. The outflow end 248 is surrounded by an immersion tube rim section 250. The immersion tube rim sections 250 of neighboring immersion tubes 162 pass into each other. The immersion tube rim sections 250 are formed in the plate section 160 of the immersion tube plate 18.

The immersion tube rim sections 250 are located, when the filter device 10 is mounted, as illustrated in FIG. 7, for example, at an axial distance 252 in relation to the free end 148 of the circumferential seal 96 radially inside of the seal section 146.

The outflow ends 248 of the immersion tubes 162 are located, viewed axially, beyond the inflow-side axial free end 148 of the circumferential seal 96. The immersion tube rim sections 250 surrounding the outflow ends 248 and thus also the outflow ends 248 of the immersion tubes 162, viewed axially, dip behind the free end 148 of the circumferential seal 96 and thus behind the inflow-side end of the main filter element 16.

Between the immersion tube plate 18 and the housing pot 12, a seal chamber 224 is realized in the mounted state in which the seal section 146 of the seal 96 and a part of the holding section 144 are arranged. The seal chamber 224 is delimited radially inwardly by the rib 164 of the immersion tube plate 18, radially outwardly by the interior wall surface 86 of the collar wall 44 of the housing pot 12, and axially by the collar 208 of the cyclone housing 20 which is connected to the immersion tube plate 18.

For mounting, for example, at a machine which requires the gaseous medium purified by the filter device 10, the filter device 10 is mounted with the short side 56, at which the particle discharge device 198 of the cyclone block 24 is arranged, spatially at the bottom. In this context, the axis 22 is substantially horizontally arranged.

In operation of the filter device 10, the gaseous medium to be purified, for example, air, is sucked in through the inlet opening 204 of the cyclone separators 166. The flow of the gaseous medium within the filter device 10 is illustrated in FIG. 6 by curved arrows.

A coarse separation of particles takes place in the cyclone separators 166. The separated particles sink, following the force of gravity, downwardly to the particle discharge device 198 where they are collected. The discharge opening 202 of the particle discharge device 198 is opened as needed or when servicing and the particle discharge device 198 is emptied.

The pre-purified gaseous medium passes through the inlet openings 168 of the immersion tubes 162 to the inflow side 226 of the main filter element 16. The inflow side 226 is located at the side of the main filter element 16 at which also the seal 96 is located.

The gaseous medium to be purified flows into the flow spaces 140 between the outer filter bellows 134 and the inner filter bellows 136. In doing so, the gaseous medium is distributed circumferentially in that it flows through the connection openings 114. From the flow spaces 140, the gaseous medium to be purified flows through the outer filter bellows 134 in radial direction from the interior to the exterior, is further purified by it, and reaches an annular space which surrounds the main filter element 16 radially outwardly. Functionally in parallel, the gaseous medium to be purified flows through the inner filter bellows 136 in radial direction from the exterior to the interior, is purified further by it, and reaches the element interior 142.

The gaseous medium from the annular space purified in the second stage and the gaseous medium from the element interior 142 purified in the second stage reach the outflow side 228 of the main filter element 16. The outflow side 228 of the main filter element 16 is located at the side which is axially facing away from the inflow side 226.

From the outflow side 228, the gaseous medium purified in the second stage flows into the after filter element 14 and is further purified by the latter.

The gaseous medium which has been purified in total in three stages exits the filter device 10 through the outlet opening 40 of the filter housing 26. From here, the purified gaseous medium is sucked in by corresponding components of the machine.

That which is claimed is:

1. A filter element for gaseous media for a filter device, the filter element comprising:
at least one filter medium body comprising a first axial end and a second axial end facing away from each other in relation to a virtual axis, wherein an inflow side is disposed at the first axial end and an outflow side is disposed at the second axial end;
a frame element connected to the at least one filter medium body and at least partially extending circumferentially around the at least one filter medium body, wherein the frame element, in relation to the virtual axis, radially projects past the at least one filter medium body;
a circumferential seal disposed at a side of the frame element facing toward the inflow side, wherein the circumferential seal extends circumferentially around the virtual axis;
at least one support section disposed at a side of the frame element facing toward the outflow side, wherein the at least one support section is configured to support the filter element at least in an axial direction in relation to the virtual axis in a filter housing of the filter device;
wherein the at least one support section comprises at least two support surfaces, distributed about a circumferential extension of the frame element in relation to the virtual axis and spaced apart from each other in the axial direction;
wherein the circumferential seal comprises a circumferential seal stay projecting in the axial direction and configured to seal at least partially radially in a radial direction in relation to the virtual axis in relation to a corresponding seal surface of the filter housing.

2. The filter element according to claim 1, wherein the circumferential seal stay projects in the axial direction past the inflow side of the at least one filter medium body.

3. The filter element according to claim 1, wherein the circumferential seal stay is arranged immediately adjacent to, in relation to the virtual axis, a radially outer wall surface of the frame element, and/or the circumferential seal stay is arranged in the radial direction completely radially outside a radially outer wall surface of the at least one filter medium body.

4. The filter element according to claim 1, wherein the circumferential seal is delimited at a side facing the outflow side by the frame element, and/or a surface of the frame element facing the outflow side is exposed at least in sections and provides the at least one support section.

5. The filter element according to claim 4, wherein the frame element, beginning at the at least one support section, extends radially inwardly and/or in a direction toward the inflow side.

6. The filter element according to claim 4, wherein the frame element is embedded at least in sections by a material of the circumferential seal.

7. The filter element according to claim 1, wherein, along a course extending around the virtual axis, the frame element comprises at least four sections, wherein respective neighboring sections of the at least four sections comprise differently curved courses and at least one pair of the at least four sections on opposite sides of the virtual axis comprise differently curved courses.

8. The filter element according to claim 1, wherein, along a course extending around the virtual axis, the circumferential seal stay comprises at least four sections, wherein respective neighboring sections of the at least four sections comprise differently curved courses and at least one pair of the at least four sections on opposite sides of the virtual axis comprise differently curved courses.

9. The filter element according to claim 1, wherein the frame element comprises at least two curved sections curved in relation to a circumferential course thereof around the virtual axis, wherein the at least two curved sections are connected by two connection sections extending around the virtual axis, wherein the two connection sections are disposed at long sides of the frame element opposite each other in relation to the virtual axis, and wherein the at least two curved sections are disposed at short sides of the frame element opposite each other in relation to the virtual axis.

10. The filter element according to claim 9, wherein the two connection sections are straight connection sections straight in relation to a circumferential course thereof around the virtual axis.

11. The filter element according to claim 9, wherein the at least two curved sections include a first curved section and a second curved section, wherein the first curved section at least in sections comprises a radius of curvature larger than a radius of curvature of the second curved section.

12. The filter element according to claim 11, wherein the first curved section comprises a flattened region in which the radius of curvature of the first curved section in relation to the radius of curvature of the second curved section is reduced.

13. The filter element according to claim 9, wherein at least one of the at least two support surfaces of the frame element is present at least partially at the long sides of the frame element.

14. The filter element according to claim 1, wherein the circumferential seal stay comprises at least two curved sections curved in relation to a circumferential course thereof around the virtual axis, wherein the at least two curved sections are connected by two connection sections, wherein the two connection sections are disposed at long sides of the circumferential seal stay opposite each other in relation to the virtual axis, and wherein the at least two curved sections are disposed at short sides of the circumferential seal stay opposite each other in relation to the virtual axis.

15. The filter element according to claim 14, wherein the two connection sections are straight connection sections straight in relation to a circumferential course thereof around the virtual axis.

16. The filter element according to claim 14, wherein the at least two curved sections include a first curved section and a second curved section, wherein the first curved section at least in sections comprises a larger radius of curvature than the second curved section.

17. The filter element according to claim 16, wherein the first curved section comprises a flattened region in which the radius of curvature of the first curved section in relation to the radius of curvature of the second curved section is reduced.

18. The filter element according to claim 1, wherein the at least one filter medium body comprises a radially outer wall surface in relation to the virtual axis and the radially outer wall surface comprises at least two curved sections curved in relation to a circumferential course thereof around the virtual axis, wherein the at least two curved sections are connected by two connection sections.

19. A filter device for gaseous media, the filter device comprising:
a filter housing comprising at least one inlet opening for a gaseous medium to be purified and at least one outlet opening for the purified gaseous medium;
at least one filter element comprising at least one filter medium body, the at least one filter element arranged in the filter housing in relation to a flow of the gaseous medium from the at least one inlet opening to the at least one outlet opening such that the at least one filter element separates a raw side correlated with the at least one inlet opening from a clean side correlated with the at least one outlet opening;
wherein the filter housing comprises a first housing part comprising at least one filter element receiving space, wherein the at least one filter element is arranged in the at least one filter element receiving space, wherein the at least one outlet opening is arranged at the first housing part;
wherein the filter housing comprises a second housing part comprising one or more parts of at least one cyclone separator, wherein the at least one inlet opening is arranged at the second housing part:
wherein the second housing part closes off a service opening of the first housing part;
wherein the first housing part and the second housing part are releasably connected to each other and separable from each other in order to be able to remove the at least one filter element from the filter housing through the service opening of the first housing part;
wherein at least one of the at least one filter element is a filter element according to claim 1.

20. A method of assembling a filter device for gaseous media, the method comprising:
inserting at least one filter element according to claim 1 through a service opening into at least one filter element receiving space of a first housing part of a filter housing of the filter device, the first housing part comprising an outlet opening for the gaseous media;
closing the service opening by a second housing part of the filter housing, the second housing part comprising an inlet opening for the gaseous media and one or more parts of at least one cyclone separator.
